(19) United States
(12) Patent Application Publication
(10) Pub. No.: US 2013/0187954 A1
(43) Pub. Date: Jul. 25, 2013

(54) IMAGE DATA GENERATION APPARATUS AND IMAGE DATA GENERATION METHOD

(71) Applicant: CANON KABUSHIKI KAISHA, Tokyo (JP)

(72) Inventors: Hiroshi Saito, Utsunomiya-shi (JP); Takuya Tsujimoto, Kawasaki-shi (JP); Hidetoshi Tsuzuki, Yokohama-shi (JP); Shuji Murakami, Zama-shi (JP)

(73) Assignee: CANON KABUSHIKI KAISHA, Tokyo (JP)

(21) Appl. No.: 13/746,491

(22) Filed: Jan. 22, 2013

(30) Foreign Application Priority Data
Jan. 25, 2012 (JP) 2012-013323
Nov. 16, 2012 (JP) 2012-251760

(51) Int. Cl. G06T 11/60

(52) U.S. Cl. CPC G06T 11/60
USPC 345/634

(57) ABSTRACT

In a case where a plurality of interest regions are designated with respect to an original image, a position data acquisition unit creates list information, in which data of respective positions of the interest regions is associated with designation order. In a case where data of a position of a newly designated interest region is acquired, a display data generation unit generates data for superimposing and displaying, on a display image, a mark indicating the position of the newly designated interest region, and a path connecting the position of the interest region designated last time and the position of the newly designated interest region.

### BACKGROUND OF THE INVENTION

1. Field of the Invention

The present invention relates to an image data generation apparatus, and an image data generation method, and more particularly to a technique of generating display image data for image diagnosis capable of improving work efficiency of pathological diagnosis.

2. Description of the Related Art

Recently, in a pathological field, a virtual slide system enabling pathological diagnosis on a display by imaging a test sample placed on a prepared slide and digitizing an image is gaining attention as an alternative for an optical microscope that is a tool of pathological diagnosis. By digitizing a pathological diagnostic image using the virtual slide system, an optical microscope image of a conventional test sample can be handled as digital data. As a result, it is expected to obtain merits such as speeding up of remote diagnosis, explanation to a patient for which an digital image is used, shared use of rear cases, promotion of education efficiency and practical training efficiency. Generally, in a case where a whole test sample is digitized, the data volume thereof becomes considerably large, that is, several hundreds of millions of pixels to several billions of pixels. Therefore, a micro image (detail enlarged image) to a macro image (whole overhead image) can be observed by performing enlarging/reducing processing on a diagnosis image viewer, thereby enabling provision of various conveniences.

On the other hand, there are provided various viewers enabling immediate display of user's desired images from low magnification images to high magnification images, not only in the pathological field. For example, in an ultrasonic diagnostic device disclosed in Japanese Patent Application Laid-open No. H6-78927, which region of a tomographic image has been enlarged and displayed can be clearly grasped by clearly specifying the corresponding relation between the tomographic image and an enlarged image of the partial region. Furthermore, in an ultrasonic diagnostic device disclosed in Japanese Patent Application Laid-open No. 2004-121652, in a case where an ultrasonic image is enlarged and displayed in a stepwise fashion, reduce processing is performed for an original image, and a generated reference image is prepared. This allows to easily understand the relation between the respective images, and to easily display the original image.

Moreover, in an information processing device disclosed in Japanese Patent Application Laid-open No. 2011-112523, when different partial images of an image of an object to be observed, which is obtained by a microscope, are continuously output, the corresponding information of the positions and the resolution of the output partial images are regularly sampled. Then, a history image representing the track of the positions and the observation magnification of the partial image is generated and displayed in a whole image, thereby enabling an observation history to be grasped while looking the whole image.

Generally, in pathological diagnosis, work referred to as screening where interest regions are designated or marked while observing an low magnification image is first performed, and thereafter, detailed observation of the respective interest regions is performed using a high magnification image. Japanese Patent Application Laid-open Nos. H6-78927 and 2004-121652 clearly specify the corresponding relation between the low magnification image and the high magnification observation image that is the interest regions, but do not disclose the corresponding relation about designated order or time between a plurality of interest regions. Therefore, when screening is performed in pathological diagnosis, the designated progress of the interest regions is unclear, and excess and deficiency of the designation of the interest regions occur. Then, redesignation work is required, and work efficiency is reduced.

On the other hand, Japanese Patent Application Laid-open No. 2011-112523 discloses a history image capable of grasping output order or time of a plurality of partial images, but does not clearly specify the corresponding relation between a generated history image and the interest regions desired to be marked. Therefore, the generated history image includes unnecessary information when performing screening, and the interest regions, which are desired to be observed in detail, cannot be clearly determined. Furthermore, corresponding relation can be represented by stopping the screening for a certain period of time every time the partial image including the interest region is output, and generating the history image, however work efficiency is reduced. Moreover, Japanese Patent Application Laid-open No. 2011-112523 discloses a history image capable of grasping the range of enlarged and output partial images, but does not clearly specify a technique of re-outputting the partial images on the basis of the history. Therefore, from the result of the screening, position redesignation and magnification designation are required in order to output and observe the enlarged images of the interest regions in detail, and work efficiency is reduced due to a cumbersome screen operation.

Although the pathological diagnosis is taken as an example, as long as the system is a system that performs screening using a low magnification image and performs detailed observation using a high magnification image, similar problems occur for the system in any field.

### SUMMARY OF THE INVENTION

The present invention has been conceived in order to solve the aforementioned problems, and the object thereof is to provide a technique capable of associating screening work for designating a plurality of interest regions with detailed observation, and independently performing the screening work and the detailed observation, capable of visually observing progress where the interest regions have been designated during the screening, and capable of improving the work efficiency of image observation.

The present invention in its first aspect provides an image data generation apparatus generating data for displaying information of an interest region designated by a user along with an image on a display device, the image data generation apparatus including: a display data generation unit that generates, from data of an original image, data of a display image corresponding to all or a part of a region of the original image, and generates data of a display screen including the display image; and a position data acquisition unit that, when a user designates an interest region with respect to the display image displayed on the display device on the basis of the data of the display screen, acquires data of a position designated as the interest region, wherein in a case where a plurality of interest regions are designated with respect to the original image, the position data acquisition unit creates list information, in which data of respective positions of the plurality of interest regions is associated with designation order, and in a case where data of a position of a newly designated interest region is acquired by the position data acquisition unit, the display data generation unit generates data for superimposing and displaying, on the display image, a mark indicating the position of the newly designated interest region, and in a case where data of a position of an interest region designated last time exists in the list information, the display data generation unit generates data for superimposing and displaying, on the display image, also a path connecting the position of the interest region designated last time and the position of the newly designated interest region.

The present invention in its second aspect provides an image data generation apparatus generating data for displaying information of an interest region designated by a user along with an image on a display device, the image data generation apparatus including: a display data generation unit that generates, from data of an original image, data of a display image corresponding to all or a part of a region of the original image, and generates data of a display screen including the display image; and a position data acquisition unit that acquires list information in which designation order and data of respective positions of a plurality of interest regions designated by a user with respect to the original image are associated with each other and listed, wherein the position data acquisition unit acquires, from the list information, the data of the respective positions of the plurality of interest regions and the designation order, and the display data generation unit generates data for superimposing and displaying, on the display image, marks indicating the respective positions of the plurality of interest regions, on the basis of the data of the respective positions of the plurality of interest regions and the designation order acquired from the list information.

The present invention in its third aspect provides an image data generation apparatus generating data for displaying information of an interest region designated by a user along with an image on a display device, the image data generation apparatus including: a display data generation unit that generates, from data of an original image, data of a display image corresponding to all or a part of a region of the original image, and generates data of a display screen including the display image; and a position data acquisition unit that acquires list information in which designation order and data of respective positions of a plurality of interest regions designated by a user with respect to the original image are associated with each other and listed, wherein the position data acquisition unit acquires, from the list information, the data of the respective positions of the plurality of interest regions and the designation order, and the display data generation unit generates data for superimposing and displaying, on the display image, marks indicating the respective positions of the plurality of interest regions, and paths sequentially connecting the positions of the plurality of interest regions, on the basis of the data of the respective positions of the plurality of interest regions and the designation order acquired from the list information.

The present invention in its fourth aspect provides an image processing system including: an imaging apparatus or an image storage device; a display device; and an image data generation apparatus generating data for performing display on the display device by using data of an image acquired from the imaging apparatus or the image storage device, wherein the image data generation apparatus is the image data generation apparatus according to the present invention.

The present invention in its fifth aspect provides an image data generation method of generating data for displaying information of an interest region designated by a user along with an image on a display device, the image data generation method including: a display data generation step in which a computer generates, from data of an original image, data of a display image corresponding to all or a part of a region of the original image, and generates data of a display screen including the display image; and a position data acquisition step in which, when a user designates an interest region with respect to the display image displayed on the display device on the basis of the data of the display screen, the computer acquires data of a position designated as the interest region, wherein in the position data acquisition step, in a case where a plurality of interest regions are designated with respect to the original image, list information is created in which data of respective positions of the plurality of interest regions is associated with designation order, and in the display data generation step, in a case where data of a position of a newly designated interest region is acquired in the position data acquisition step, data for superimposing and displaying, on the display image, a mark indicating the position of the newly designated interest region is generated, and in a case where data of a position of an interest region designated last time exists in the list information, data for superimposing and displaying, on the display image, also a path connecting the position of the interest region designated last time and the position of the newly designated interest region is generated.

The present invention in its sixth aspect provides an image data generation method of generating data for displaying information of an interest region designated by a user along with an image on a display device, the image data generation method including: a display data generation step in which a computer generates, from data of an original image, data of a display image corresponding to all or a part of a region of the original image, and generates data of a display screen including the display image; and a position data acquisition step in which the computer acquires list information in which designation order and data of respective positions of a plurality of interest regions designated by a user with respect to the original image are associated with each other and listed, wherein in the position data acquisition step, the data of the respective positions of the plurality of interest regions and the designation order are acquired from the list information, and in the display data generation step, data for superimposing and displaying, on the display image, marks indicating the respective positions of the plurality of interest regions is generated on the basis of the data of the respective positions of the plurality of interest regions and the designation order acquired from the list information.

The present invention in its seventh aspect provides an image data generation method of generating data for displaying information of an interest region designated by a user along with an image on a display device, the image data generation method including: a display data generation step in which a computer generates, from data of an original image, data of a display image corresponding to all or a part of a region of the original image, and generates data of a display screen including the display image; and a position data acquisition step in which the computer acquires list information in which designation order and data of respective positions of a plurality of interest regions designated by a user with respect to the original image are associated with each other and listed, wherein in the position data acquisition step, the data of the respective positions of the plurality of interest regions and the designation order are acquired from the list information, and in the display data generation step, data for superimposing and displaying, on the display image, marks indicating the respective positions of the plurality of interest regions, and paths sequentially connecting the positions of the plurality of interest regions is generated on the basis of the data of the respective positions of the plurality of interest regions and the designation order acquired from the list information.

The present invention in its eighth aspect provides a non-transitory recording medium recording a program for causing a computer to execute the respective steps of the image data generation method according to the present invention.

According to the present invention, it is possible to associate screening work for designating a plurality of interest regions with detailed observation and independently perform the screening work and the detailed observation, to visually observe progress where the interest regions have been designated during the screening, and to improve the work efficiency of image observation.

Further features of the present invention will become apparent from the following description of exemplary embodiments with reference to the attached drawings.

### BRIEF DESCRIPTION OF THE DRAWINGS

FIG. 1 is a configuration diagram of an image processing system including an image data generation apparatus according to a first embodiment;

FIG. 2 is a hardware configuration diagram of the image data generation apparatus according to the first embodiment;

FIG. 3 is a function block diagram of the image data generation apparatus according to the first embodiment;

FIGS. 4A to 4D show examples of a display screen configuration during screening according to the first embodiment;

FIG. 5 is a flowchart of display image data generation during the screening;

FIG. 6 is a flowchart of generation/updating of interest region marks during the screening;

FIGS. 7A to 7D show examples of a display screen configuration during detailed observation according to the first embodiment;

FIG. 8 is a flowchart of display image data generation during the detailed observation according to the first embodiment;

FIG. 9 is a configuration diagram of an image processing system including an image data generation apparatus according to a second embodiment;

FIG. 10 is a function block diagram of the image data generation apparatus according to the second embodiment;

FIG. 11 shows a format example of a list of interest regions generated during screening;

FIG. 12 is a flowchart of display image data generation during reproduction and display of a path;

FIGS. 13A and 13B show examples of a display screen configuration during specific path display according to a third embodiment;

FIG. 14 is a flowchart of display image data generation during the specific path display;

FIG. 15 is a flowchart of display image data generation in which a path is added;

FIG. 16 is a flowchart of importance determination during screening according to a fourth embodiment;

FIG. 17 shows a format example of a path list for enabling selection of a path according to a fifth embodiment;

FIGS. 18A and 18B show examples of a display screen configuration of displaying an enlarged image around the path according to the fifth embodiment;

FIG. 19 is a flowchart of display image data generation in which the enlarged image around the path is displayed;

FIGS. 20A and 20B show another example of a display screen configuration displaying the enlarged image around the path according to the fifth embodiment;

FIGS. 21A and 21B show examples of a display screen configuration of a display track according to a sixth embodiment; and

FIG. 22 is a function block diagram of a position data acquisition unit according to the fourth embodiment.

### DESCRIPTION OF THE EMBODIMENTS

### First Embodiment

A first embodiment achieving the present invention will be described with reference to the figures.

(Configuration of Image Processing System)

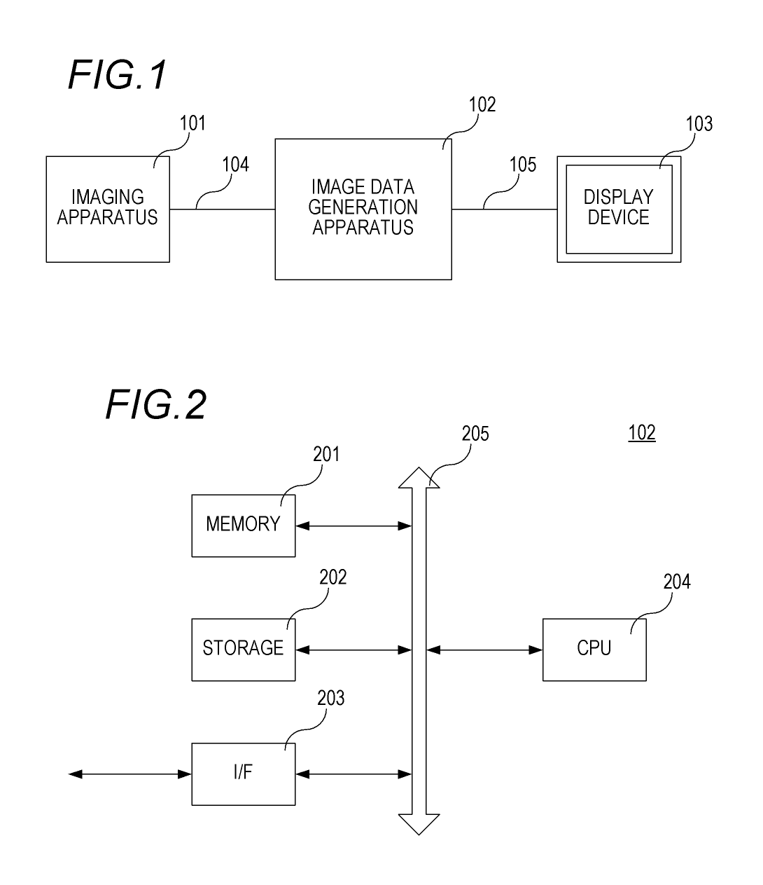

FIG. 1 is a configuration diagram of an image processing system including an image data generation apparatus for describing the first embodiment of the present invention. The system of FIG. 1 is configured from an imaging apparatus (a microscope apparatus, or a virtual slide scanner) 101, an image data generation apparatus 102, and a display device 103, and has a function of acquiring and displaying a two-dimensional image of a specimen (test sample) that is an object to be imaged. A dedicated or general-purpose I/F cable 104 connects between the imaging apparatus 101 and the image data generation apparatus 102, and a dedicated or general-purpose I/F cable 105 connects between the image data generation apparatus 102 and the display device 103.

The imaging apparatus 101 has a function of imaging a two-dimensional image, and outputting acquired two-dimensional image data to an external device. The imaging apparatus may be a digital microscope device in which a digital camera is mounted on an ocular unit of a general optical microscope. A solid-state image sensing device such as a charge coupled device (CCD) and a complementary metal oxide semiconductor (CMOS) is employed to acquire the two-dimensional image data.

The image data generation apparatus 102 has a function of generating, from the two-dimensional image data acquired from the imaging apparatus 101, display data for displaying an image or information suitable for pathological diagnosis. The image data generation apparatus 102 can be configured by a general-purpose computer or a workstation enabling high speed arithmetic processing, which includes hardware resources such as a central processing unit (CPU), a RAM, a storage device, an operation unit, and an I/F. The storage device is a high-capacity information storage device such as a hard disk drive, and stores a program or data for achieving respective processing described later, an operating system (OS), and the like. The CPU loads programs and data necessary for the RAM from the storage device and runs the programs, thereby achieving the aforementioned respective functions. The operation unit is configured by a keyboard, a pointing device, or the like, and utilized in order for an operator to input various instructions. The display device 103 described later may have a function of operation input by employing a touch panel.

The display device 103 is a monitor having a function of displaying the image or information suitable for the pathological diagnosis on the basis of the display data generated by the image data generation apparatus 102, and can be configured by a CRT, a liquid crystal display, or the like.

In an example of FIG. 1, while the image processing system is configured by the three devices, that is, the imaging apparatus 101, the image data generation apparatus 102, and the display device 103, the configuration of the present invention is not limited to this configuration. For example, an image data generation apparatus integrated with a display device may be used, or the function of the image data generation apparatus may be incorporated into the imaging apparatus. Furthermore, the functions of the imaging apparatus, the image data generation apparatus, and the display device can be achieved by a single device. On the contrary, the functions of the image data generation apparatus and the like may be divided and achieved by a plurality of devices.

FIG. 2 is a figure showing an example of a hardware configuration of the image data generation apparatus 102. The image data generation apparatus 102 of FIG. 2 has a memory 201, a storage (storage device) 202, an I/F 203, a CPU 204, and an internal bus 205.

The memory 201 is a storage device that has an area for temporarily storing captured (picked-up) image data acquired from external by the image data generation apparatus 102, or display data generated inside, or a work area used for performing various processing with the CPU 204. Here, a DRAM device such as a double-data-rate 3 (DDR 3) is used. The storage 202 is a non-volatile storage device that stores a program or data for allowing the CPU 204 to perform the respective processing performed by the image data generation apparatus 102, image data or a list desired to be stored in the image data generation apparatus 102, and setting data. Here, a device such as an HDD or an SSD is used. The I/F 203 is an interface device for acquiring the captured image data from external, outputting the display data to external, or acquiring operation information from external with the image data generation apparatus 102. Here, a device such as a USB, a Gigabit Ethernet (registered trademark) and DVI can be used. The CPU 204 is an arithmetic processing device for running a program, which manages whole behavior of the image data generation apparatus 102, such as initial setting, control of various devices, and image data processing. Here, a CPU of a general-purpose computer or a workstation is used. The internal bus 205 is an internal bus connecting the aforementioned respective devices. Here, a serial bus such as a PCI Express is used.

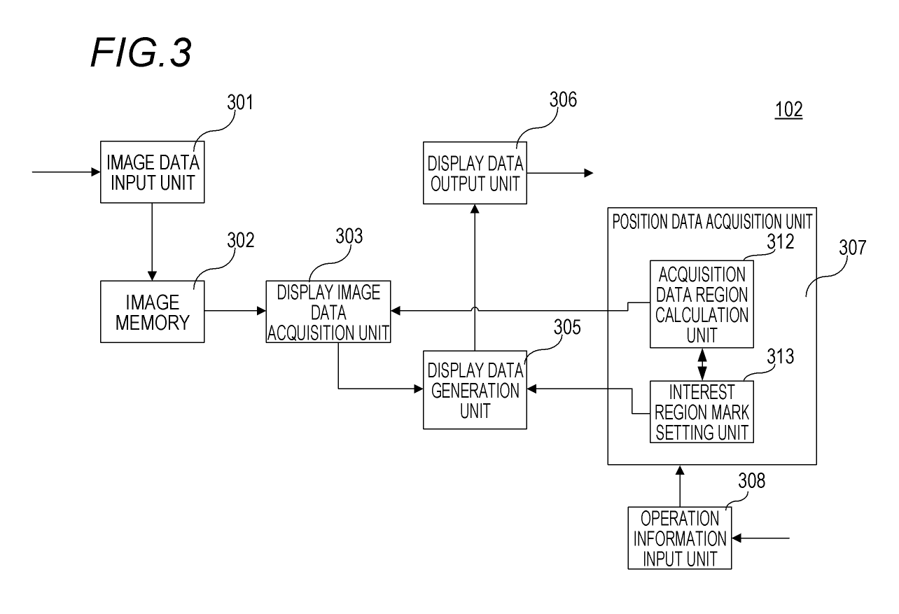

FIG. 3 is a function block diagram of the image data generation apparatus 102 according to the first embodiment of the present invention. The image data generation apparatus 102 is configured from an image data input unit 301, an image memory 302, a display image data acquisition unit 303, a display data generation unit 305, a display data output unit 306, a position data acquisition unit 307, and an operation information input unit 308. Furthermore, the position data acquisition unit 307 is configured from an acquisition data region calculation unit 312, and an interest region mark setting unit 313.

The image data input unit 301 has a function of inputting the captured (picked-up) image data acquired by the imaging apparatus 101, and outputting the same to the image memory 302. While imaging apparatus recognition means (not shown) desirably automatically recognizes the connected imaging apparatus 101 and changes the format of the input captured image data, the format of the input captured image data may be set by a user.

The image memory 302 stores the captured image data associated with position coordinates. For example, in a case where an captured image with N×N pixels is present, position coordinates of the pixel at a left upper corner of the captured image are defined as (0, 0), position coordinates on a right hand side of the position coordinate of the pixel at the left upper corner are defined as (1, 0), position coordinates of the pixel at a left lower corner are defined as (0, N), and position coordinates of the pixel at a right lower corner are defined as (N, N). Respective image data corresponding to a plurality of position coordinates is stored in the image memory 302 as the captured image data associated with the position coordinate. The respective captured image data is stored, for example, from address number 0 of the image memory 302 in order of the position coordinates. Accordingly, the address numbers and the position coordinates on the captured image data can be designated on a one-on-one basis. Furthermore, the captured image data stored in the image memory 302 may be either black and white image data or color image data. However, the color image data is configured by three RGB image data for the respective position coordinates. Moreover, the captured image data is preferably configured from a plurality of hierarchical image data (i.e., a plurality of image data with different resolution at the same angle of view) corresponding to an observation magnification. Accordingly, any hierarchical image data corresponding to the position coordinates on the captured image data can be input and output by designating the observation magnification and memory address.

The display image data acquisition unit 303 acquires, from the image memory 302, image data on a region designated by the position data acquisition unit 307 described later. In a case where the designated region is rectangular, the designation of the aforementioned region may be represented by using the position coordinates on four corners of the designated region, represented by a combination of the left upper position coordinates and the right lower position coordinates, or represented by position coordinates, which are the head of the region, and the numbers (region widths) of the respective horizontal and vertical pixels.

The display data generation unit 305 has a function of generating data (referred to as display data) for displaying, on the display device 103, a display screen configured by a display image, a pointer image, a list image, an interest region mark, and the like. Display regions or display position coordinates on the display device 103 of respective parts (images) are designated on the basis of information acquired by the position data acquisition unit 307.

The display image is an image of an object to be observed, which is generated from the captured image data. The pointer image is an image of a mouse pointer. The list image is an image indicating a list of the information of the interest region designated by the user. The interest region mark is information for clearly specifying a position, at which the interest region is designated, to the user, and is superimposed and displayed at a display position on the display image, corresponding to the position coordinates on the captured image data of the interest region. In a case where the designation of the interest region is a second point or subsequent point, the display data generation unit 305 generates data of a path for clearly specifying the position relation between an interest region mark designated last time and an interest region mark designated this time, together with the interest region marks. The path may be either a straight line or a curved line connecting between two points. In a case of the curved line, it is desirable to consider a position and a distance of an interest region mark designated before last time but one. While the curved line may be obtained by any method, a curved line with a long distance and a small curvature radius is not desirable because paths interfere with each other and this makes determination of the user difficult.

The display data output unit 306 has a function of outputting the display data to the display device 103. The format of the output display data corresponds to various signals such as a RGB signal and a brightness color-difference signal. Furthermore, the format thereof also arbitrarily corresponds to the resolution (the number of pixels) of the display device 103. These setting can desirably changed by recognizing the connecting display device 103 with display device recognition means (not shown), but may be set by the user.

The operation information input unit 308 has a function of acquiring, from the operation unit (not shown), operation/setting information such as movement of the mouse pointer, operation determination, and number input, which is operated and set by the user, and outputting the same to the position data acquisition unit 307.

The position data acquisition unit 307 has a function of generating the following data on the basis of the operation/setting information such as movement of the mouse pointer, operation determination, and number input, which is operated and set by the user. That is, the position data acquisition unit 307 generates an acquisition region and a display magnification of the display image data, and the list image data. Moreover, the position data acquisition unit 307 generates the display regions on a screen of the display image and the list image, and the display position coordinates on the screen of the pointer image and the interest region mark.

The interest region mark setting unit 313 is a part of the function configuring the position data acquisition unit 307, and has a function of performing the following on the basis of the display position coordinates of the pointer image on the screen, and the display region on the screen, the display magnification, and acquisition region of the display image data. That is, the interest region mark setting unit 313 has a function of acquiring the position coordinates on the captured image data in the interest region, generating a list associated with the display magnification, generating the list image data, and generating the display position coordinates of the interest region mark on the screen of the display device 103. The position coordinates of the interest region, acquired herein are position coordinates on the captured image data corresponding to a position representative of the inside of the interest region, are here defined as position coordinates which is the head of the region. The display position coordinates of the interest region mark are generated as the display position coordinates on the display image in the display device 103, which correspond to the position coordinates on the captured image data of the interest region.

The acquisition data region calculation unit 312 is a part of the function configuring the position data acquisition unit 307, and has a function of calculating the acquisition region of the display image data by the position coordinates and the display magnification on the captured image data, of the image to be displayed, and the display region in the display device 103.

The image data generation apparatus 102 of FIG. 3 operates the following by using the aforementioned functions. That is, the image data input unit 301 inputs the captured image data acquired by the imaging apparatus 101 in the image memory 302. The position data acquisition unit 307 acquires the position coordinates on the captured image data of the image to be displayed, in accordance with an instruction from the operation unit (not shown). Thereafter, the display data generation unit 305 acquires, from the image memory 302, the image data of the region corresponding to the position coordinates, generates the display data, and outputs the generated display data to the display device 103. Furthermore, the position data acquisition unit 307 creates a list where the position coordinates on the captured image data, corresponding to the interest region designated on the display image are associated with a magnification for display. Then, the position coordinates on the captured image data of the image data, which is desired to be generated as display data, can be selected from the list. Moreover, the position data acquisition unit 307 calculates the display position coordinates of the interest region mark, corresponding to the designated interest region, when the interest region is designated. Then, the display data generation unit 305 generates display data where the interest region mark is updated, and outputs the generated display data to the display device 103.

(Screening Work)

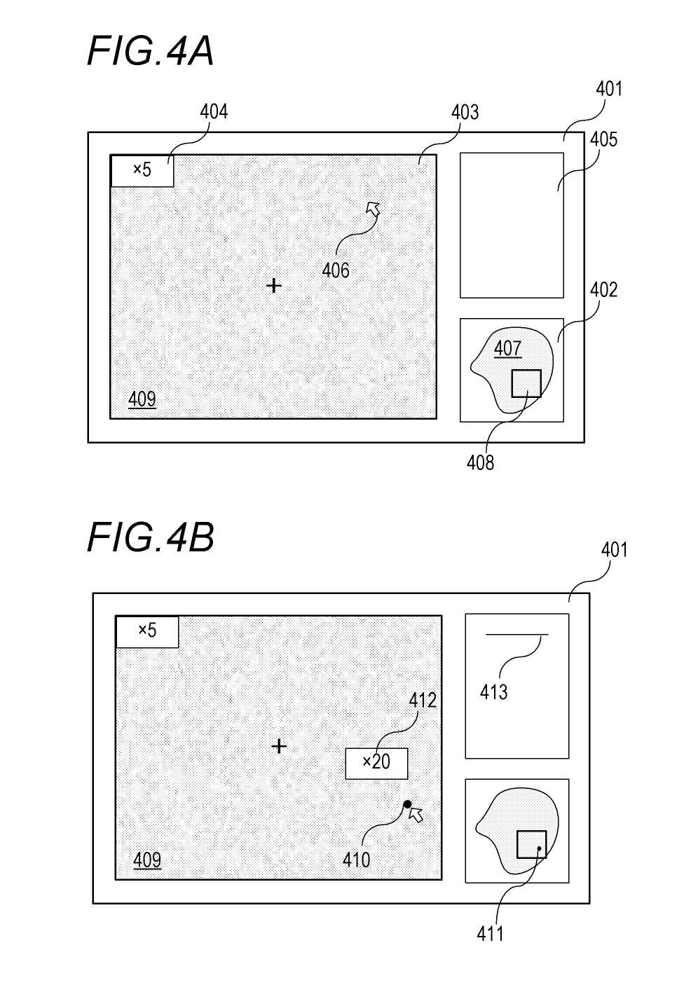

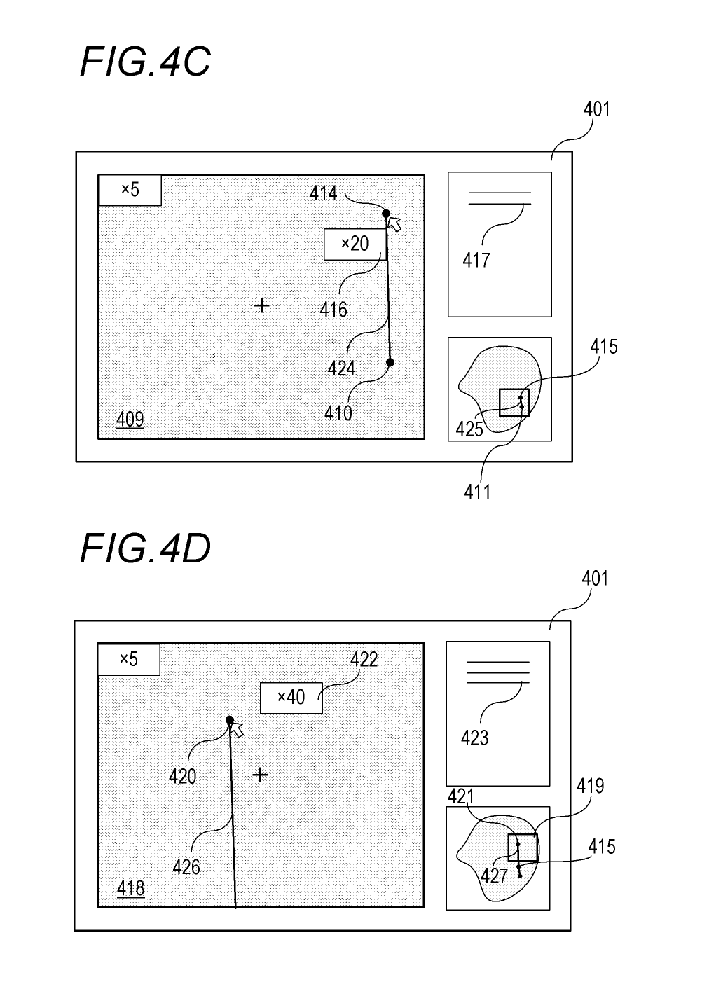

FIG. 4A to FIG. 4D each show a display screen configuration example during screening work according to the first embodiment of the present invention.

As shown in FIG. 4A, a display screen 401 of the display device 103 during screening work is configured from a whole image display unit 402, an observation image display unit 403, an observation magnification display unit 404, and an interest region information display unit 405. The user can arbitrarily set a display region in the display device 103 from the operation unit (not shown). Furthermore, a pointer image 406 moving in accordance with movement information of a pointer from the operation unit (not shown) is displayed.

The whole image display unit 402 displays a whole image 407 where the whole of captured image data acquired from the imaging apparatus 101 is reduced in size, and a region designation frame 408 of the display image according to the observation magnification displayed on the observation image display unit 403.

The observation image display unit 403 displays display image based on the position coordinates on the captured image data designated by the user at a display magnification indicated by the observation magnification display unit 404 as an observation image 409.

The observation magnification display unit 404 displays a display magnification set by the user. FIG. 4A shows an example where a five-fold display magnification is set.

The interest region information display unit 405 displays an image of a list of the interest region. In this list image, information of the interest regions designated/set by the user is arranged in order of listing/setting. Each item of the list corresponds to a single interest region, and information displayed on each item includes position coordinates on the captured image data of the interest region, an interest region display magnification, and the like. The user can select the item in the list image by using the operation unit. In FIG. 4A, since no interest region is yet designated, the interest region information display unit 405 displays an empty list.

The interest region can be designated by moving a pointer 406 to a corresponding position on the observation image 409 with the operation unit, and performing a predetermined determination operation such as pressing of a bottom. In this case, the position coordinates of the interest region is obtained by converting position coordinates on the observation image 409 designated by the pointer 406 to the position coordinates on the captured image data. Alternatively, the interest region may be designated and set by directly inputting position coordinate values on the captured image data or display position coordinate values on the display screen 401.

FIG. 4B shows an example of the display screen 401 when a first point interest region is designated from a state of FIG. 4A. An interest region mark 410 is displayed on a position corresponding to the first point interest region on the observation image 409, and an interest region mark 411 is also displayed at a position corresponding to the first point interest region on the whole image 407. Here, the interest region mark 410 is a mark on the observation image 409 with a magnification of five-fold. Accordingly, the position data acquisition unit 307 calculates display position coordinates in the display device 103 of the interest region mark 410 from the acquired position coordinates on the captured image data of the interest region, the display region of the observation image display unit 403, and information of a magnification of five-fold. In a case where the interest region is designated with the pointer 406, the display position coordinates of the interest region mark coincide with display position coordinates in the display device 103 of the pointer 406. Furthermore, in a case where a configuration, in which display position coordinate values on the display screen 401 are directly input, is employed, the display position coordinates of the interest region mark coincide with the input values. On the other hand, the interest region mark 411 is a mark on the whole image 407. Accordingly, the position data acquisition unit 307 calculates display position coordinates in the display device 103 of the interest region mark 411 from the acquired position coordinates on the captured image data of the interest region, the display region of the whole image display unit 402, and information of a reduction ratio of a whole image.

When the interest region is designated, an interest region display magnification input unit 412 for inputting a display magnification (interest region display magnification) used when observing the interest region in detail is displayed. FIG. 4B shows an example where a magnification of 20-fold is input as the interest region display magnification. Furthermore, the interest region information display unit 405 displays an interest region display magnification for detailed observation together with the position coordinates on the captured image data of the first point interest region obtained here as interest region information 413. In a case where a configuration, in which the interest region display magnification input here can be selected from a candidate list previously prepared by the user, is employed, simple screening work can be performed. On the other hand, a configuration, in which an adaptive magnification can be input, may be employed as a configuration capable of directly inputting values.

FIG. 4C shows an example of the display screen 401 when a second point interest region is further designated from a state of FIG. 4B. Similarly to FIG. 4B, a second point interest region mark 414 on the observation image 409, an interest region mark 415 on the whole image 407, an interest region display magnification 416 for detailed observation, and interest region information 417 are updated and displayed. Display position coordinates in the display device 103 of the interest region marks 414 and 415 are calculated by the position data acquisition unit 307, similarly to the interest region marks 410 and 411. Furthermore, when the interest region mark 414 is displayed, the display position coordinates in the display device 103 of the interest region mark 410 previously designated are simultaneously recalculated. The display position coordinates which have been calculated once may be associated with the interest region, and stored in the list, and display position coordinates of respective interest region marks may be acquired from the list. However, when the display region or the display magnification of the observation image is changed, the display position coordinates calculated in the past cannot be used as they are. Therefore, in this case, the display position coordinates stored in the list are cleared or recalculated. Then, the display data generation unit 305 generates data of a straight line (path or movement path) 424 connecting the two interest region marks 410 and 414 on the basis of the coordinates of the two interest region marks 410 and 414, and updates and displays the same on the observation image 409. A path 425 connecting the interest region marks 411 and 415 is generated and displayed similarly.

FIG. 4D shows an example of the display screen 401 when a third point interest region is further designated from a state of FIG. 4C. FIG. 4D shows an example where after the second point interest region is designated in FIG. 4C, the display region of the observation image is moved in an upper right direction, and the third point interest region is designated.

In a case where the operation unit (not shown) instructs movement of the display region, the position coordinates on the captured image data, corresponding to the display region after the movement are updated, and a new observation image 418 is generated and displayed on the basis of the updated position coordinates and the display magnification. Furthermore, a region designation frame 419 is displayed at a position corresponding to a display region of the new observation image 418 on the whole image 407. Following the movement of the display region, destination display position coordinates of the first point and second point interest region marks 410 and 414 and the path therebetween are also updated. However, in FIG. 4D, both of the marks and the path are not present in the display region, and therefore are not displayed. The movement of the display region can be instructed, for example, by dragging or scrolling the region designation frame 419 on the whole image with the operation unit, or dragging or scrolling the observation image. Alternatively, a configuration, in which position coordinate values of the display region after the movement are directly input, may be employed.

When the third point interest region is designated in FIG. 4D, an interest region mark 420 on the observation image 418, an interest region mark 421 on the whole image 407, an interest region display magnification 422 for detailed observation, and an interest region information 423 are updated and displayed. Here, an example where 40-fold is input and designated as the interest region display magnification for detailed observation is shown. Display position coordinates in the display device 103 of the interest region marks 420 and 421 are calculated by the position data acquisition unit 307, similarly to the interest region marks 410 and 411. Furthermore, when the interest region mark 420 is displayed, the display position coordinates of the interest region marks 410 and 414 previously designated are simultaneously recalculated. Alternatively, as described above, in a case where display position coordinates calculated in the past are stored in the list, the display position coordinates can be acquired and utilized. At this time, recalculation of the interest region mark apparently unnecessary to be drawn on the display screen 401 may be omitted.

The display data generation unit 305 generates data for drawing the straight lines (paths) connecting between the interest region marks in order of designation. As a result, a part 426 of a path between the interest region marks 420 and 414, which is present in the display region of the observation image display unit 403 is displayed on the observation image 409. A path 427 between the interest region marks 421 and 415 is displayed similarly.

In the screening work, the aforementioned display behavior is repeated until the designation of all the interest regions is terminated, and the designation of a plurality of the interest regions can be easily and intensively performed. Furthermore, order of designation of the interest regions is clearly specified with the paths, and hence it is possible to designate the interest regions while confirming the history of the designation of the interest regions.

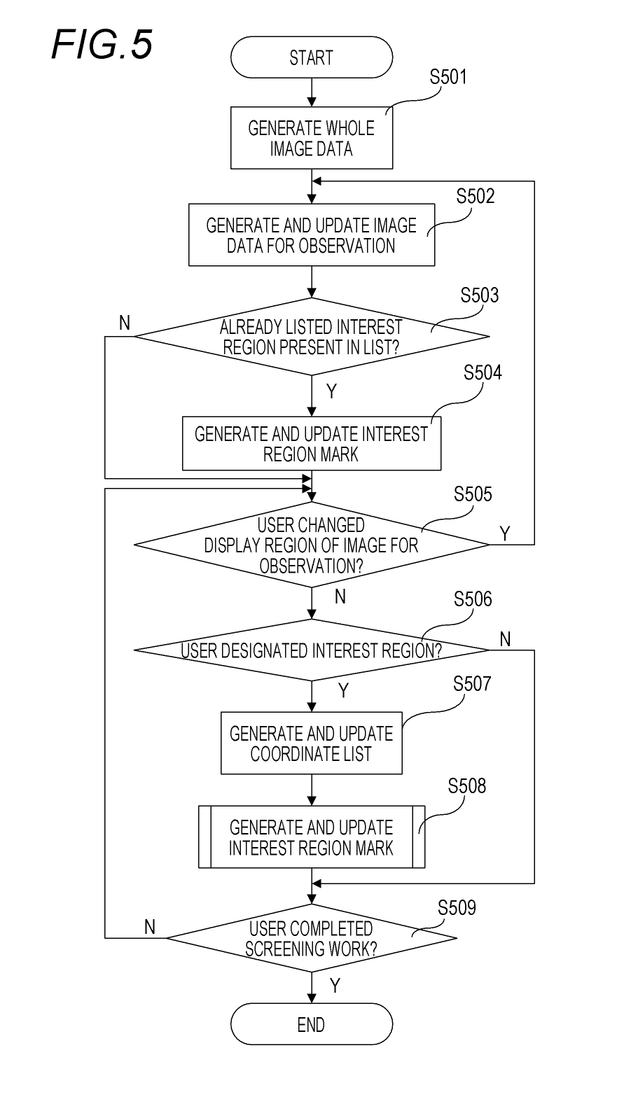

FIG. 5 is a flowchart for illustrating generation of the display image data during the screening work according to the first embodiment of the present invention.

In Step S501, display data for displaying the whole image 407 is generated. The display data generation unit 305 performs resolution conversion of captured image data read out from the image memory 302 so as to conform to the display region of whole image display unit 402, and generates whole image data. Processing of Step S501 can be increased in speed or omitted by previously preparing data for display after the resolution conversion for the whole image 407.

In Step S502, image data of a region of an observation image to be displayed is read out from the image memory 302, and observation image data is generated. As a result, the display data for displaying as in FIG. 4A is generated. When the display region of the observation image is changed upon receipt of a result of Step S505 described later, image data corresponding to the changed region is read in from the image memory 302, and new observation image data is generated and updated.

In Step S503, the interest region mark setting unit 313 determines whether or not the data of the interest region already listed in the list is present. In a case where the already listed data is present, the process advances to Step S504. In a case where the already listed data is not present, that is, the user has never designated the interest region, the process advances to Step S505.

In Step S504, the interest region mark setting unit 313 and the display data generation unit 305 update the interest region mark and the path. First, the interest region mark setting unit 313 acquires position coordinates on captured image data of the respective interest regions from the list, and calculates display position coordinates on the display screen of interest region marks corresponding to these. The calculated display position coordinates of interest region marks are given to the display data generation unit 305 in order of listing in the list. The display data generation unit 305 calculates display position coordinates of straight lines (paths) for connecting the adjacent interest region marks in the order of listing in the list (i.e., order of designation). Then, the display data generation unit 305 extracts only coordinates existing in the display region of the observation image display unit 403 from the calculated coordinate values, and generates and updates the data of the interest region marks and the paths on the basis of these. In a case where the display position coordinates of the interest region marks are associated with the interest regions and stored in the list, the display position coordinates may not be recalculated, and display position coordinates read in from the list may be used.

In Step S505, the position data acquisition unit 307 determines whether the display region of the observation image is changed or not (the display region is moved or not, the display magnification is changed or not, etc.). In a case where the display region of the observation image is changed, the process returns to Step S502, and the display data is updated. In a case where the display position coordinates of the interest region mark are stored in the list, the display position coordinates are also updated, or the display position coordinates are cleared. In a case where the display region is not changed, the process advances to Step S506.

In Step S506, the position data acquisition unit 307 (interest region mark setting unit 313) determines whether or not the user designates the interest region. In a case where the interest region is not designated, the process advances to Step S509. In a case where the interest region is designated, the process advances to Step S507.

In a case where the interest region is designated, the interest region mark setting unit 313 acquires position coordinates on the captured image data, corresponding to the interest region designated by the user in Step S507. Moreover, the interest region mark setting unit 313 acquires interest region display magnification set by the user for detailed observation of the interest region. A configuration, in which a default value of the interest region display magnification is set, and used as it is, may be employed. For example, in a case where screening is performed by using a 5-fold to 10-fold observation image, when a 20-fold image is set for the detailed observation, the set value can be used in a case where change is particularly made. In a case where observation at 40-fold is required, the interest region display magnification should set to 40-fold only for a relevant interest region. Then, the interest region mark setting unit 313 adds the information (the position coordinates on the captured image data, and the interest region display magnification) of this interest region as a new item in the list. At this time, the list is generated so as to have such a data configuration that the order of designation of the interest regions is seen (for example, a data configuration in which items are arranged in the order of designation, or the like). Then, the interest region mark setting unit 313 generates the list image data on the basis of the information of the updated list, in order to add information of a newly designated interest region to the interest region information display unit 405, and gives the same to the display data generation unit 305. Thus, display of the interest region information display unit 405 is updated.

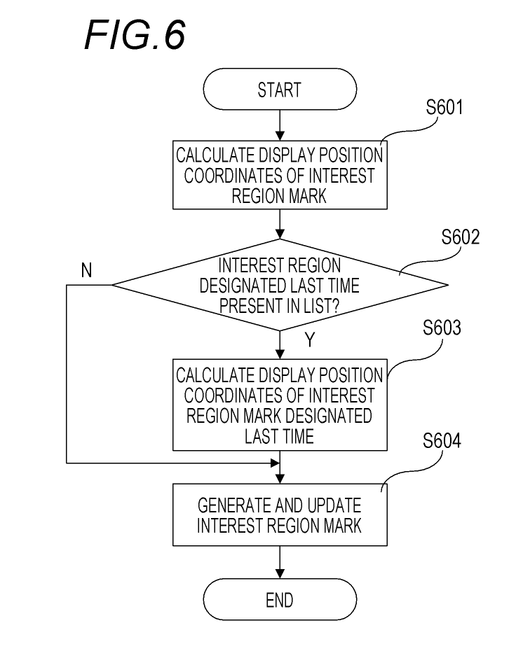

In Step S508, the interest region mark setting unit 313 and the display data generation unit 305 update an interest region mark and a path corresponding to the newly designated interest region. The detailed process will be described later with reference to FIG. 6. As a result, the display data for displaying screens as in FIG. 4B to FIG. 4D is generated.

In Step S509, it is determined whether or not the screening work is completed. In a case where the screening work is completed, that is, in a case where the work is transferred to detailed observation with a high magnification, or in a case where instruction on read-in of another specimen image is made in order to start screening work of another specimen, this display data generation processing is terminated. In a case where it is determined that the screening work is continuously performed, the process returns to Step S505, and transfers to a waiting state of change of the display region of the observation image.

Here, a configuration, in which the list thus created is stored in the storage 202, may be employed. Furthermore, a configuration, in which this list is output to external of the device (other computer, a network storage, or the like) through the I/F 203, may be employed. Moreover, the list can be desirably associated with a file of the captured image data and managed. As an association method, information of the file of the captured image data may be listed in the list, or information of the list may be listed in the file of the captured image data.

The list can be thus stored and output, thereby allowing another user to use the information of the interest region obtained by the screening work. Alternatively, the information of the interest region obtained by past screening work can be used later. Moreover, a configuration, in which the display position coordinates of the interest region mark once generated are listed in the list, while corresponding to each item in the list, is employed, thereby eliminating the need to recalculate the display position coordinates every time the display position coordinates are read out from the list. However, in this case, when the magnification or the display region in the display device 103 is changed, it is necessary to update the display position coordinates stored in the list, or to clear (delete) the display position coordinates.

FIG. 6 is a flowchart showing detailed process of the step (Step S508 of FIG. 5) of further generating and updating the interest region mark during the screening work.

In Step S601, the interest region mark setting unit 313 calculates display position coordinates on the observation image 409 in the display device 103 and display position coordinates on the whole image 407 from the position coordinates on the captured image data of the new interest region designated in Step S506. The calculated display position coordinates on the respective images are given to the display data generation unit 305.

In Step S602, the interest region mark setting unit 313 determines whether or not the data of the interest region designated last time is present in the list. In a case where the data is present, that is, in a case of designation of the second point or subsequent point interest region, the process advances to Step S603. In a case where the data is not present, that is, in a case of designation of the first point interest region, the process advances Step S604.

In S603, the interest region mark setting unit 313 acquires, from the list, position coordinates on the captured image data, corresponding to an interest region designated last time. Then, the interest region mark setting unit 313 calculates display position coordinates on the observation image in the display device 103, and display position coordinates on the observation image in the display device 103, of the straight line (path) connecting the two points on the basis of both of the coordinates. Similarly, the interest region mark setting unit 313 calculates display position coordinates on the whole image 407. The display position coordinates of the interest region designated last time are already calculated, and in a case where the coordinate values thereof can be acquired from the interest region mark setting unit 313 or the list, a configuration, in which the already calculated coordinate values are acquired (utilized) in Step S603, may be employed.

In Step S604, the display data generation unit 305 generates and updates the data of the interest region mark and the path on the basis of the coordinates existing in the display region of the observation image display unit 403, among the respective coordinates calculated in Step S601 and Step S603. Similarly, the data of the interest region mark and the path on the whole image 407 are generated and updated.

The form of the path to be displayed may be an arrow directed from the interest region designated last time to the interest region newly designated. A starting point side and an ending point side of the path can be easily visually distinguished by the arrow, and hence the user can easily grasp the progress of designating the interest regions. A display form capable distinguishing the starting point side and the ending point side is not limited to the arrow, and can be achieved also by line width, change in color (gradation, or the like), and animation.

(Detailed Observation)

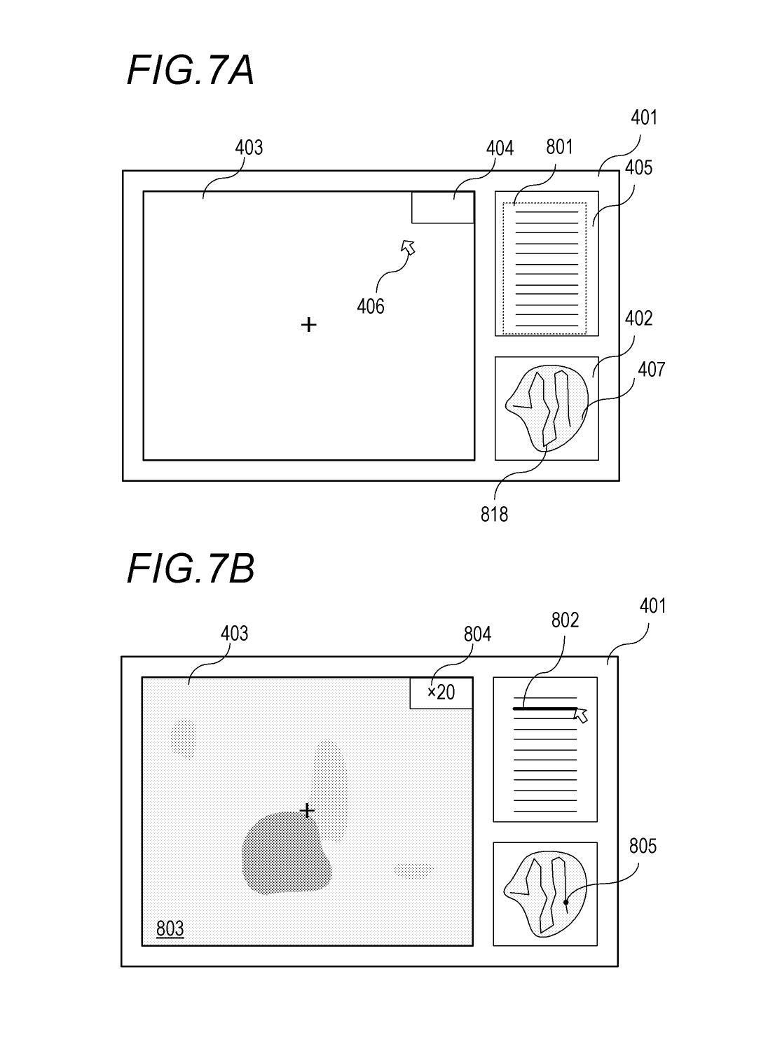

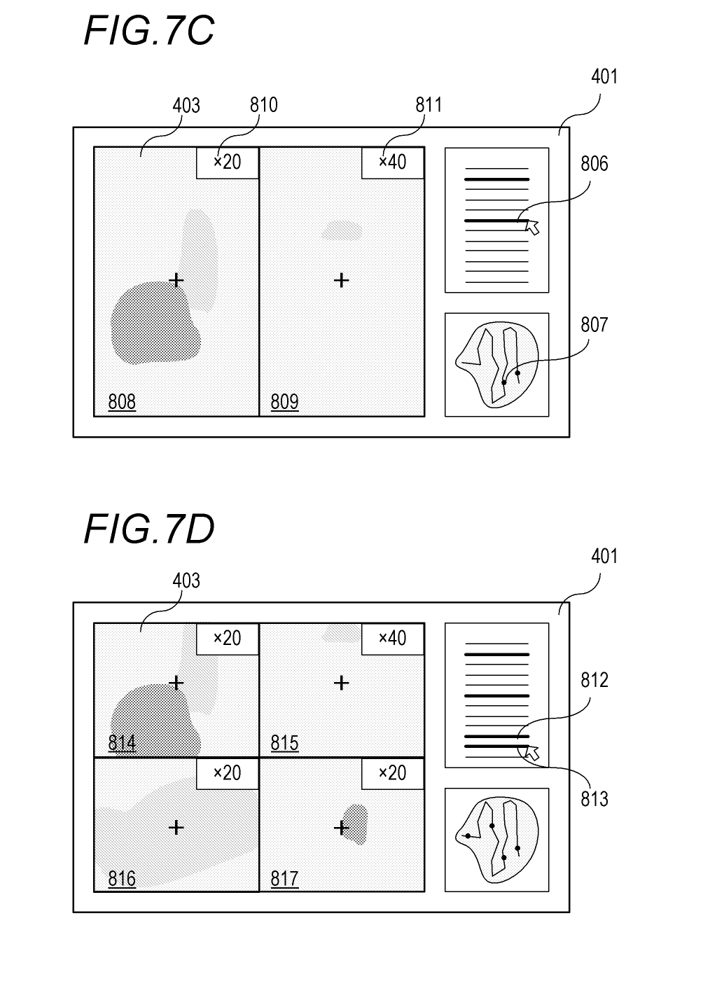

FIG. 7A to FIG. 7D each show an example of a display screen configuration during detailed observation according to the first embodiment of the present invention.

As shown in FIG. 7A, the display screen 401 of the display device 103 during the detailed observation is configured from the whole image display unit 402, the observation image display unit 403, the observation magnification display unit 404, and the interest region information display unit 405, which are similar to those during the screening work. The user can arbitrarily set display region on the display device 103 from the operation unit (not shown). Furthermore, the pointer image 406 moving in accordance with movement information of the pointer from the operation unit (not shown) is displayed.

The whole image display unit 402 displays the whole image 407 obtained by reducing the size of the whole of captured image data acquired from the imaging apparatus 101. Then, interest region marks and a path 818 created and updated during screening work are displayed on the whole image 407.

The interest region information display unit 405 displays information of interest regions generated during screening in a list. In this list 801, the information of the interest regions designated/set by the user is arranged in order of designation/setting. Each item of the list corresponds to the single interest region, and the information displayed on each item includes position coordinates on the captured image data of the interest region, an interest region display magnification, and the like. The user can select the item, for which detailed observation is performed, from the list 801 by using the operation unit. A configuration, in which the user does not select the item from the list 801, but can directly input coordinates or a display magnification of the region to be desired to be observed in detail, with reference to the information displayed in the list, may be employed.

The observation image display unit 403 displays an enlarged display image of a region corresponding to the interest region selected from the list by the user. In FIG. 7A, nothing is displayed because the interest region is not yet selected. Alternatively, a configuration, in which a low magnification image with a magnification of about 10-fold, displayed during the screening, is displayed in an initial state (state where no interest region is selected), may be employed.

The observation magnification display unit 404 displays an interest region display magnification for detailed observation of the interest region selected from the list by the user. In FIG. 7A, the list is blank because no interest region is yet selected. In a case where a low magnification image with a magnification of about 10-fold, displayed during the screening, is displayed, 10-fold is displayed.

FIG. 7B shows an example of the display screen 401, in which a first point interest region is selected from a state of FIG. 7A. An item 802 corresponding to the first point interest region selected on the list 801 is highlighted. Furthermore, the observation image display unit 403 displays an enlarged display image 803 corresponding to the selected first point interest region at a corresponding interest region display magnification. The interest region display magnification is a display magnification for detailed observation stored when the interest region is listed. Here, since the first point enlarged display image 803 is a single point of the selected interest region, the whole display region of the observation image display unit 403 is fully used and displayed. Furthermore, the observation magnification display unit 404 displays an interest region display magnification 804 for detailed observation of the first point interest region. FIG. 7B shows an example of a display magnification of 20-fold. Furthermore, an interest region mark 805 at a position corresponding to the first point interest region on the whole image 407 is highlighted.

FIG. 7C shows an example of the screen 401, in which a second point interest region is selected from a state of FIG. 7B. An item 806 on the list 801, corresponding to the second point interest region is further highlighted, and a second point interest region mark 807 on the whole image 407 is additionally highlighted. On the other hand, the observation image display unit 403 displays enlarged display images 808 and 809 corresponding to the first point and second point interest regions respectively are displayed side by side at respective corresponding interest region display magnifications. Here, since there are the two selected interest regions, the respective enlarged display images are displayed by dividing the whole display region of the observation image display unit 403 into two. Furthermore, observation magnification display units 404 are displayed on respective enlarged display image regions, and respective interest region display magnifications 810 and 811 are displayed.

FIG. 7D shows an example of the display screen, in which two interest regions are further selected from a state of FIG. 7C. Similarly to FIG. 7C, items 812 and 813 on the list 801, corresponding to third point and fourth point interest regions are additionally highlighted, and a total of four interest region marks on the whole image 407 are highlighted. On the other hand, the observation image display unit 403 displays enlarged display images 814, 815, 816 and 817 corresponding to the first point to fourth point interest regions respectively are displayed side by side at respective corresponding interest region display magnifications. Here, the respective enlarged display images are displayed by dividing the whole display region of the observation image display unit 403 into four. Furthermore, observation magnification display units 404 are displayed on respective enlarged display image region, and respective interest region display magnifications are displayed.

In detailed observation work, the aforementioned display behavior is repeated by selection of the interest region by the user, and a plurality of the interest regions can be simultaneously observed in detail. Furthermore, the whole image, in which a path showing the order of the designation of the interest regions during screening is superimposed and displayed, is arranged along with the image for observation, thereby enabling detailed diagnosis to be performed while confirming the progress of the screening.

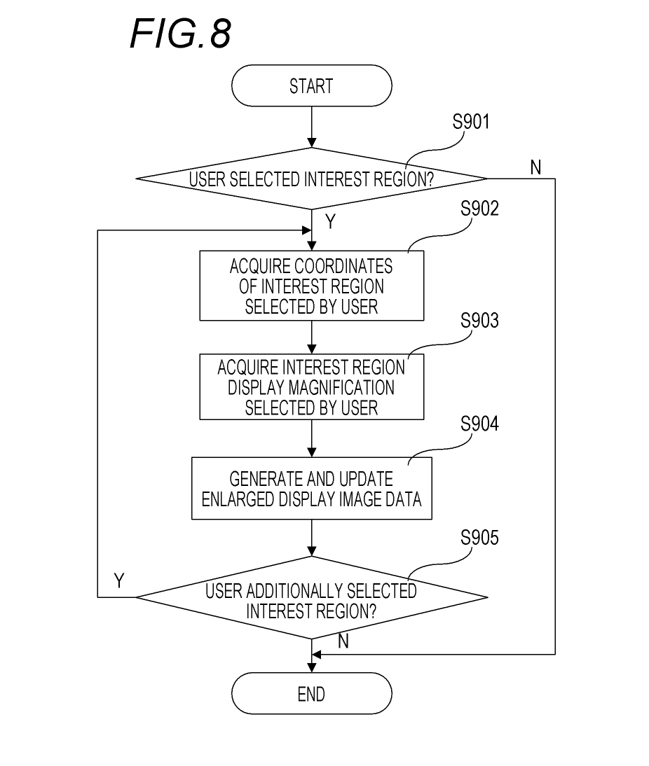

FIG. 8 is a flowchart for illustrating generation of the display data during the detailed observation according to the first embodiment of the present invention.

In Step S901, the position data acquisition unit 307 determines whether or not the user selects any of the interest regions from the list of the interest regions. In a case where the interest region is selected, the process advances to Step S902. In a case where the interest region is not selected, the processing of the display image data generation for the detailed observation is terminated.

In Step S902, the position data acquisition unit 307 acquires, from the list of the interest regions, position coordinates on the captured image data, corresponding to the interest region selected by the user. Then, in Step S903, the position data acquisition unit 307 acquires, from the list of the interest regions, an interest region display magnification, corresponding to the interest region selected by the user.

In Step S904, the display image data acquisition unit 303 reads out, from the image memory 302, image data corresponding to a region of the enlarged display image selected by the user, on the basis of a region calculated from the position coordinates and the interest region display magnification acquired by the position data acquisition unit 307. Thereafter, the display data generation unit 305 generates display data reflecting enlarged observation image data through the display image data acquisition unit 303.

Finally, in Step S905, it is determined whether an interest region is additionally selected or not. In a case where the additional selection is made, the process returns to Step S902, and generation of the enlarged display image data for detailed observation is thereafter repeated. In a case where the additional selection is not made, the processing of the display image data generation for the detailed observation is terminated. A screen of the detailed observation shown in FIG. 7D is displayed by using the display image data thus generated.

The list provided for the display screen during the detailed observation is generally generated based on the list information, which is created during screening work performed at a stage prior to detailed observation and is stored in the memory 201. However, a configuration, in which list information generated in screening work performed in the past or in screening work performed at another place (another device) can be read in from the storage 202, or can be acquired from external of the device through the I/F 203, may be employed. Moreover, a configuration, in which the captured image data is re-entered in a case where the captured image data stored in the memory 201 does not coincide with the captured image data associated with the list, is desirably employed.

The list information can be thus read out and input, thereby enabling another user to perform detailed observation by using the information of the interest region obtained by the screening work. Alternatively, the detailed observation can be performed by reutilizing the information of the interest region obtained by past screening work. Here, in a case of performing the detailed observation work on the basis of the information thus read out from the list, it is desirable to generate and update the data of the interest region mark and the path on the whole image and the list prior to Step S901, and to enable the display of the display image shown in FIG. 7A.

With the configuration and the behavior according to the first embodiment, described above, the user can designate a plurality of the interest regions in the screening work of pathological diagnosis while confirming the history of the designation of the interest regions. Furthermore, the user can select a plurality of the interest regions in detailed observation work while confirming the progress of the screening. As a result, excess and deficiency of the screening or the selection of the interest regions can be prevented, a screen operation is simplified, and work efficiency can be improved. Furthermore, a designation process of a screening worker can be reproduced, and hence a list generated by an experienced pathologist can be applied to a pathology education of a freshman, for example.

### Second Embodiment

A second embodiment achieving the present invention will be described with reference to the figures.

According to the first embodiment, the example of displaying the path showing the order of designation of the interest regions during the screening work or the detailed observation work is shown. According to the present embodiment, a function of drawing interest region marks and paths one by one (or group by group in a case where the number of the interest regions is large) in accordance with order of designation of the interest regions is provided. That is, this function is a function of reproducing and displaying the progress of the designation of the interest regions during screening work by a user. At this time, it is preferable to adjust such that not only the order of the drawing, but also a time interval of display (drawing) of each interest region mark conforms to a time interval of actual designation of each interest region in the screening work. This enables the intention of the screening worker to be faithfully reproduced. In the following second embodiment, an example of reproducing both the order of the designation of the interest regions and the time interval of the designation is shown.

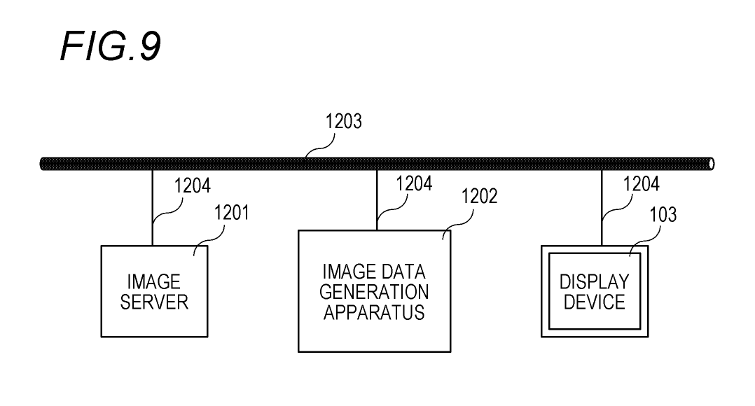

FIG. 9 is a configuration diagram of an image processing system including an image data generation apparatus according to the second embodiment of the present invention.

The system of FIG. 9 is configured from an image server (image storage device) 1201, an image data generation apparatus 1202, and a display device 103, and has a function of acquiring and displaying a two-dimensional image of a specimen (test sample) that is an object to be displayed. The image server 1201, the image data generation apparatus 1202, and the display device 103 are connected by general-purpose LAN cables 1204 through a network 1203. Alternatively, the image server 1201 and the image data generation apparatus 1202, or the image data generation apparatus 1202 and the display device 103 may be connected by general-purpose I/F cables such as numeral numbers 104 and 105 shown in FIG. 1.

The image server 1201 has a function of storing the two-dimensional image data of the specimen imaged by an imaging apparatus 101 having a function of imaging the two-dimensional image. The image data generation apparatus 1202 has a function of acquiring the imaged two-dimensional image data from the image server 1201, and generating a display data for displaying information and an image suitable for pathological diagnosis. A configuration of the image data generation apparatus 1202 achieving this function is similar to that of the image data generation apparatus 102 illustrated in FIG. 1 and FIG. 2, and the detailed description thereof will be omitted.

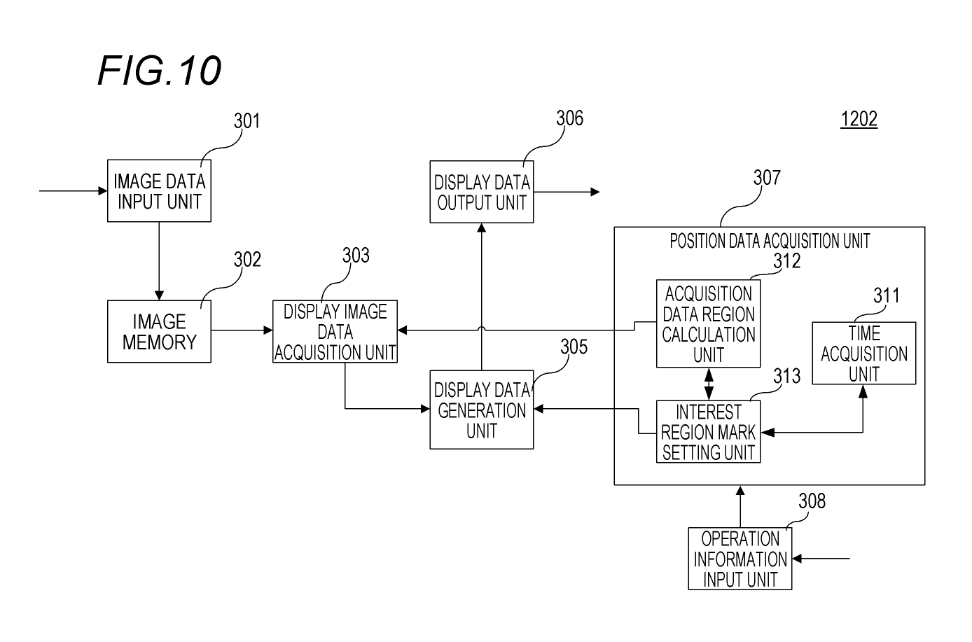

FIG. 10 is a function block diagram of the image data generation apparatus 1202 according to the second embodiment of the present invention. The image data generation apparatus 1202 of FIG. 10 is configured by a similar function block to the image data generation apparatus 102 illustrated in FIG. 3, except that a time acquisition unit 311 is added to the position data acquisition unit 307.

The time acquisition unit 311 is a part of the function configuring the position data acquisition unit 307, and has a function of acquiring a time when an interest region mark setting unit 313 acquires position coordinates corresponding to the interest region. Furthermore, the time acquisition unit 311 has a function of selecting an interest region from a list to read out the acquisition time of the interest region, and setting a time for reading out the position coordinates corresponding to the interest region, and selecting a next interest region.

The interest region mark setting unit 313 has a function of generating a list in which the respective acquisition times are associated with the position coordinates corresponding to the interest regions, in addition to the function illustrated in FIG. 3. Furthermore, the interest region mark setting unit 313 has a function of reading out position coordinates, which are referred in order to generate display image data, an interest region mark, and a path, in accordance with the time set by the time acquisition unit 311.

The image data generation apparatus 1202 of FIG. 10 runs by using the aforementioned function, as described below. That is, an image data input unit 301 inputs captured image data stored in the image server 1201 in an image memory 302. The position data acquisition unit 307 acquires position coordinates on the captured image data of an image to be displayed, in accordance with an instruction from an operation unit (not shown). Thereafter, the display data generation unit 305 acquires, from the image memory 302, image data of a region corresponding to the position coordinates, generates display data, and outputs the generated display data to the display device 103. Furthermore, the position data acquisition unit 307 creates a list in which the position coordinates on the captured image data, corresponding to the interest region designated on the display image are associated with the acquisition time of the position coordinates. Then, the position coordinates on the captured image data of the image data desired to be generated as display data can be selected from the list. Moreover, the position data acquisition unit 307 reads out the acquisition time of the position coordinates corresponding to the interest region from the list. Then, the position coordinates, which are referred in order to generate the display images, the interest region marks, and the paths are sequentially read out from the list at intervals according to the acquisition times. Then, the display data generation unit 305 sequentially generates display images, or display data including updated interest region marks, and paths, and outputs the generated display data to the display device 103.

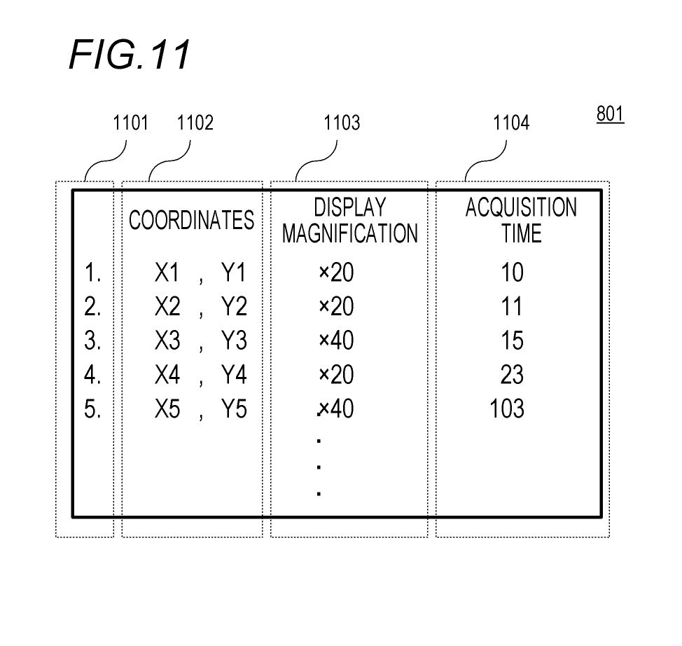

FIG. 11 is a format example of the list of the interest regions generated during screening work.

As shown in FIG. 11, a list 801 of the interest regions generated during the screening work is configured from an item number column 1101, an interest region coordinate column 1102, an interest region display magnification column 1103, and an acquisition time column 1104, for each item. The flow of screening work generating this list 801 is similar to the flow of FIG. 5, except that the acquisition time of the position coordinates corresponding to the interest region is acquired, and the list is created such that the position coordinates are associated with the acquisition time, in Step S507 of FIG. 5.

Serial numbers are generated and listed in the item number column 1101 in order of acquisition of the interest regions. While FIG. 4B and the like represent the interest region marks as round figures, a configuration, in which these numbers are superimposed and displayed on an observation image or a whole image as the interest region marks, may alternatively be employed. Furthermore, alphabets or figures capable of distinguishing the items may be displayed as the interest region marks. In the interest region coordinate column 1102, position coordinates on the captured image data, corresponding to the acquired interest regions are associated with item numbers, and listed for each line. In the interest region display magnification column 1103, interest region display magnifications corresponding to the acquired interest regions are associated with the item numbers, and listed for each line. In the acquisition time column 1104, acquisition times of the position coordinates corresponding to the interest regions are associated with the item numbers, and listed for each line. While FIG. 11 shows an example of listing the number of seconds of progress from the starting time of the screening work as the acquisition time, the time from any point of time may be listed. Furthermore, the acquisition time is not limited to the listing of the number of seconds.

FIG. 11 schematically shows an example of a data configuration of the list information, and an example of a list image displayed on the interest region information display unit 405. Information not displayed in the list image can be included in the list information. For example, display position coordinates on the display device 103 displaying each item of the list image may be associated with the item number, and listed and managed in the list information. This coordinates information can be utilized in order to determine which item is selected when the list image has been pressed with a mouse pointer, for example. The determination as to whether or not the list image exists at a position of the mouse pointer should be made by using a method of enabling selection of an already drawn figure like a method used in general drawing device and the like. Moreover, when display position coordinates of the interest region mark, which are calculated once, are listed in the list information, there is no need to recalculate the display position coordinates every time the interest region mark is displayed. However, in a case where the display position coordinates is written in the list information, when the magnification or the display region on the display device 103 is changed, the display position coordinates in the list information need to be updated.

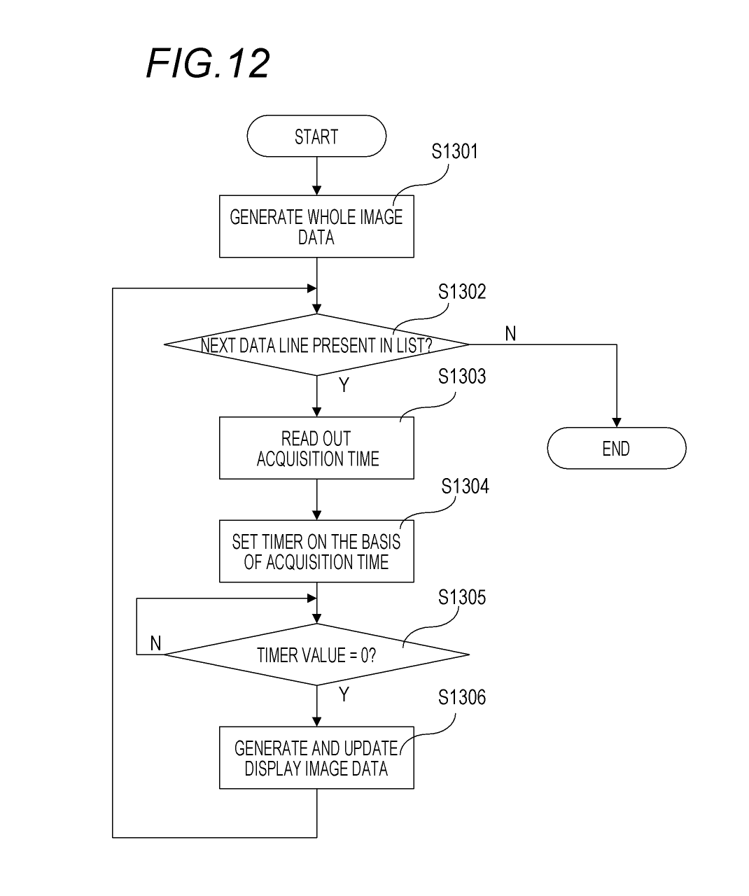

FIG. 12 is a flowchart for illustrating generation of display image data at the time of reproduction and display of the path according to the second embodiment of the present invention.

First, in Step S1301, the display data generation unit 305 generates a whole image data, and updates display data for displaying the whole image on an observation image display unit 403. This flow may be the same processing as Step S501 of FIG. 5 (however, the observation image display unit 403 is a display destination, and hence the whole image is generated so as to conform to resolution of the observation image display unit 403).

In Step S1302, the time acquisition unit 311 determines whether or not a data line associated with a next item number is present in the list. In a case where the next data line is present, the data line is selected, and the process advances to Step S1303. In a case where the next data line is not present, reproduction and display of the path are terminated.

In Step S1303, the time acquisition unit 311 reads out an acquisition time from the data line selected in Step S1302.

In Step S1304, the time acquisition unit 311 sets a timer on the basis of the acquisition time read out in Step S1303, and a countdown is started. A difference from an acquisition time of last time is used as a start value of the timer. Alternatively, the difference may be a value multiplied by any constant.

In Step S1305, the time acquisition unit 311 determines whether or not the timer value reaches 0. In a case where the timer value reaches 0, the interest region mark setting unit 313 reads out position coordinates on the captured image data, corresponding to the interest region, from the data line selected in Step S1302, and the process advances to Step S1306. In a case where the timer value is not 0, the process returns to Step S1305, and monitoring of the timer value is repeated.

In Step S1306, the display data generation unit 305 generates display image data including an updated interest region mark and a path, and updates the display data. This flow is performed based on the position coordinates on the captured image data, which are read out in Step S1305, similarly to Steps S601 to S604 of FIG. 6. Thereafter, the process returns to Step S1301, and search of the next data line in the list is thereafter repeated.

In a case where only designation order is reproduced, processes regarding the time in Steps S1303 to S1306 are not performed, the flow of reading out the position coordinates on the captured image data, corresponding to the interest region should be employed in Step S1306, after selecting the data line in Step S1302. In this case, the interest region mark and the path may be updated at a constant time interval.

Alternatively, a configuration, in which the observation image display unit 403 can display an image for detailed observation of the position coordinates on the captured image data, which are read out in Step S1305, in place of the whole image, may be employed. In this case, in place of selection by a user, selection in Step S1302 should be made in the flow of FIG. 8. Moreover, a configuration, in which the image for detailed observation is not additionally displayed every selection, but is sequentially changed to an image for detailed observation of the interest region selected at present, may be employed. Alternatively, a configuration, in which an image for observation displayed at the time of designation of the interest region is displayed, and the interest region mark and the path can be displayed also on this image, may be employed. In this case, information representing the region of the image for observation displayed at the time of the designation of the interest region needs to be associated with the interest region and listed in the list.

With the configuration and the behavior according to the second embodiment, described above, the user can reproduce and confirm the progress of sequentially designating a plurality of the interest regions in the screening work in order of the designation at a time interval according to the time of the designation. As a result, the designation process such as “how long does a screening worker spend to designate for which interest region” can be faithfully reproduced, and hence can be more adequately applied to pathology education.

### Third Embodiment

A third embodiment achieving the present invention will be described with reference to the figures.

According to the second embodiment, the example of sequentially drawing the interest region marks and the paths on the display image in the order of designation of the interest regions or according to time intervals is shown. According to the present embodiment, a function of selecting a path of a specific interest region from among a sequence of interest regions designated by a screening worker, and displaying the same is provided.

A device configuration can be achieved by a device configuration equivalent to those described in the first and second embodiments, and the detailed description thereof will be omitted.

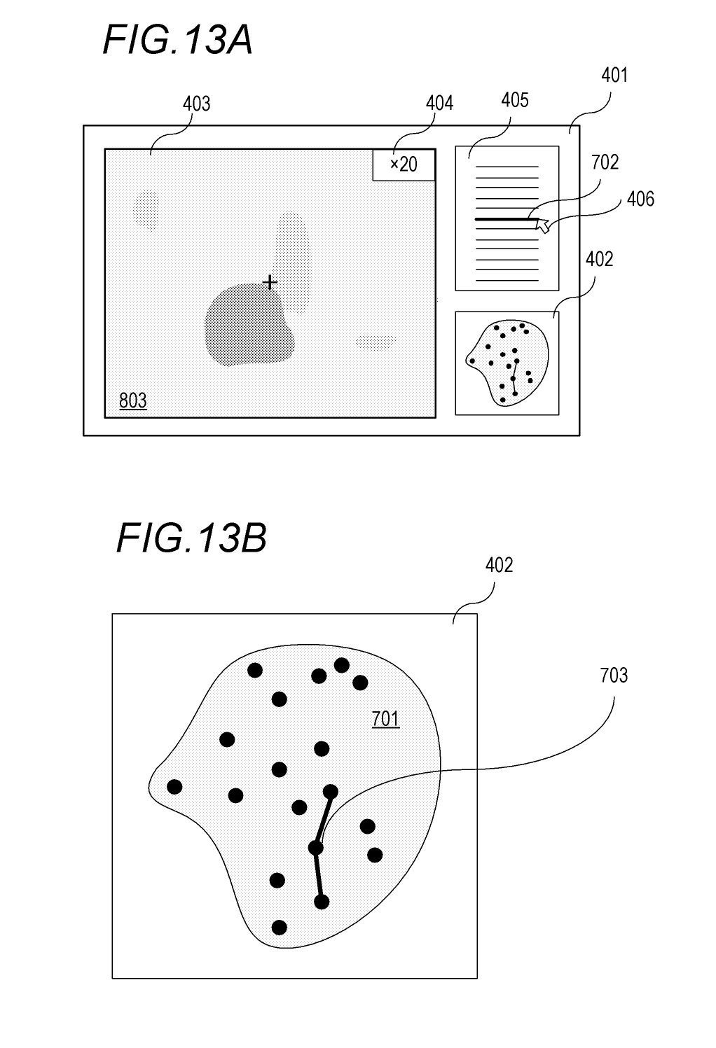

FIG. 13A and FIG. 13B each show an example of a display screen configuration at the time of display of a specific path according to the third embodiment of the present invention.

As shown in FIG. 13A, a display screen 401 of a display device 103 according to the third embodiment is configured from a whole image display unit 402, an observation image display unit 403, an observation magnification display unit 404, and an interest region information display unit 405, which are similar to those of the first embodiment. A user can arbitrarily set a display region on the display device 103 from an operation unit (not shown). Furthermore, a pointer image 406 moving in accordance with movement information of a pointer from the operation unit (not shown) is displayed.

The whole image display unit 402 displays a whole image 701 where the whole of captured image data acquired from an imaging apparatus 101 is reduced in size. Then, an interest region mark created and updated during screening work is displayed on the whole image 701. In an initial state, no path is displayed.

The interest region information display unit 405 displays information of an interest region generated during screening in a list. The user can select the item, for which detailed observation is performed, from the list by using the operation unit. A configuration, in which the user does not select the item from the list, but can directly input coordinates of the region, for which path display is desired to be performed, with reference to the information displayed in the list, may be employed.

FIG. 13A shows an example of selecting one interest region on the display screen 401 configured as described above. That is, an item 702 corresponding to the interest region selected on the list is highlighted. Furthermore, a path connected to an interest region mark 703 at a position corresponding to the selected interest region, on the whole image 701 is additionally displayed.

Here, the observation image display unit 403 displays an enlarged display image 803 corresponding to the selected interest region at a corresponding interest region display magnification. While the enlarged display image 803 is displayed by using the whole display region of the observation image display unit 403, an enlarged display image of a region connected to the additionally displayed path may be displayed simultaneously (so as to be arranged together spatially) as in FIG. 7D. Alternatively, the observation image display unit 403 may display the whole image 701. In this case, an whole image conforming to resolution of the observation image display unit 403 is generated.

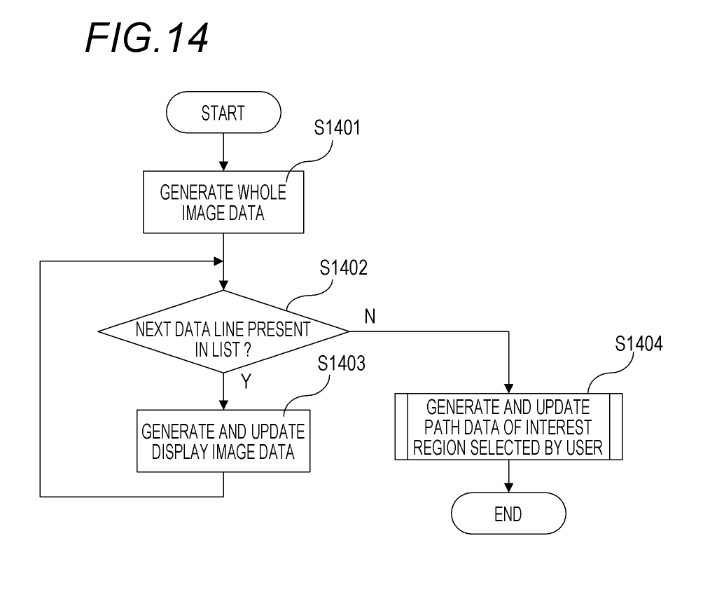

FIG. 14 is a flowchart for illustrating generation of display image data at the time of the display of the specific path according to the third embodiment of the present invention.

Processes of Steps S1401 to S1403 can be achieved by those of Steps S1301, S1302, and S1306 of the flowchart at the time of reproduction and display in the order of the designate of the paths according to the second embodiment of the present invention illustrated in FIG. 12. That is, in Step S1401, a display data generation unit 305 generates a whole image data, and the observation image display unit 403 displays the whole image.

In Step S1402, a position data acquisition unit 307 determines whether or not a data line associated with a next item number is present in the list. In a case where the next data line is present, the data line is selected, and the process advances to Step S1403. In a case where the next data line is not present, addition of a sequence of the interest region marks is terminated, and the process advances to Step S1404.

In Step S1403, the position data acquisition unit 307 reads out position coordinates on the captured image data, corresponding to the interest region, from the data line selected in Step S1402. Then, a display data generation unit 305 generates display image data including an updated interest region mark, and updates the display data. At this point, a path is not added to the display image. Thereafter, the process returns to Step S1402, and search of the next data line in the list is thereafter repeated.

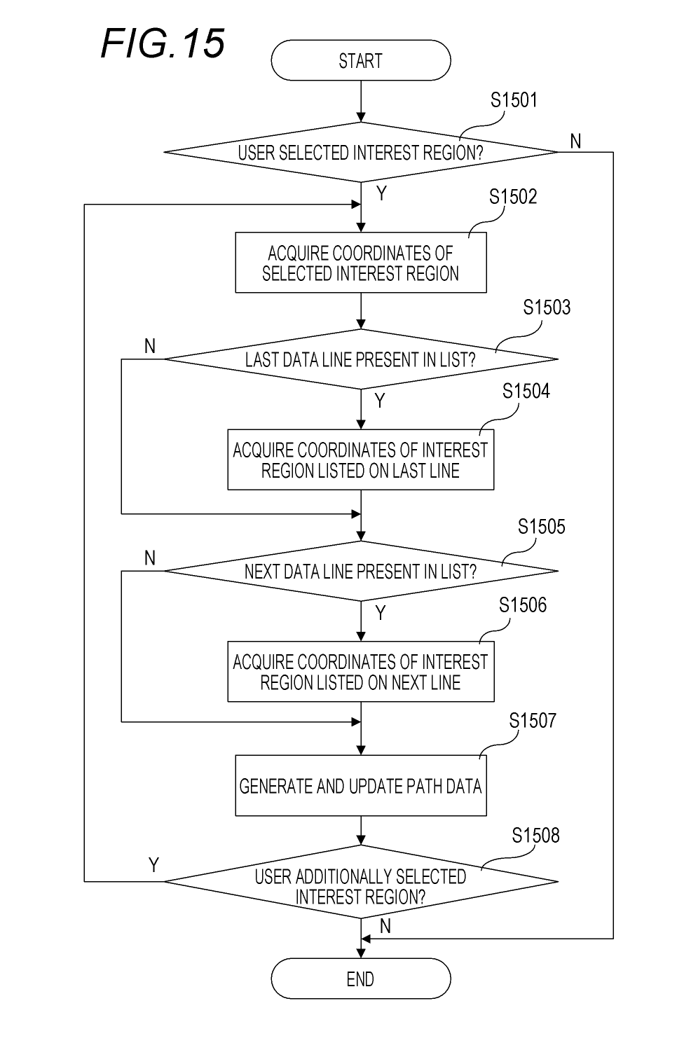

In Step S1404, display image data, in which the path connected to the interest region selected by the user is added, is generated and updated. This process will be later described in detail with reference with FIG. 15. As a result, the display data is updated to display data for displaying such a screen as to be shown in FIG. 13A.

FIG. 15 is a flowchart for illustrating detailed processing of a process of generating the display image data, in which the path connected to the interest region selected by the user is added.

In Step S1501, the position data acquisition unit 307 determines whether or not the user selects any of the interest regions from the list of the interest regions. In a case where the interest region is selected, the process advances to Step S1502. In a case where the interest region is not selected, the processing of the generation of the display image data, in which the path is added, is terminated.

In Step S1502, the position data acquisition unit 307 acquires, from the list of the interest regions, position coordinates on the captured image data, corresponding to the interest region selected by the user.

In Step S1503, the position data acquisition unit 307 determines whether or not data line associated a last item number is present in the list. In a case where the last item number is present, the data line is selected, and the process advances to Step S1504. In a case where the last item number is not present, the process advances to Step S1505.

In Step S1504, the position data acquisition unit 307 acquires, from the list of the interest region, position coordinates on the captured image data, corresponding to an interest region selected as the last line.

In Step S1505, the position data acquisition unit 307 determines whether or not data line associated a nest item number is present in the list. In a case where the next item number is present, the data line is selected, and the process advances to Step S1506. In a case where the last item number is not present, the process advances to Step S1507.

In Step S1506, the position data acquisition unit 307 acquires, from the list of the interest region, position coordinates on the captured image data, corresponding to an interest region selected as the next line.

In Step S1507, the display data generation unit 305 generates path data connected to the interest region selected by the user on the basis of the coordinates acquired in Steps S1502, S1504 and S1506 by the position data acquisition unit 307, and generates the display image data. Then, display data reflecting the display image data is updated. Thus, paths connecting the interest region selected by the user and interest regions before and after the interest region are displayed.

Finally, in Step S1508, it is determined whether an interest region is additionally selected or not. In a case where the additional selection is made, the process returns to Step S1502, and generation of the display image data, in which the path is added, is thereafter repeated. In a case where the additional selection is not made, the processing of the generation of the display image data, in which the path is added, is terminated.

In a case where the observation image display unit 403 displays an enlarged display image 803 corresponding to the selected interest region, processes of Steps S902 to S904 shown in FIG. 8 should be combined in processes of Steps S1503 to S1507.

With the configuration and the behavior according to the third embodiment, described above, the user can focus on the specific interest region, and confirm the path designated by a screening worker. As a result, it is possible to review or expect order of the designation of the specific interest regions from among a sequence of the interest regions, and to compare the same with order of actual designation, thereby enabling more adequate application to pathology education.

### Fourth Embodiment

A fourth embodiment achieving the present invention will be described with reference to the figures.

According to the present embodiment, a function of determining importances of paths of interest regions on the basis of conditions upon designation of interest regions designated by a screening worker, and clearly specifying the results thereof is provided.

For example, in a case where during screening work, a time interval up to designation of a next interest region is longer than a time interval up to designation of another region, there is a high possibility that an important feature confusing the screening worker's determination as to the designation of the interest region exists around the region. According to the present embodiment, an example of performing importance determination by employing the time interval up to the designation of the next interest region as a condition will be described.

A device configuration can be achieved by a device configuration equivalent to those described in the first and second embodiments except for the position data acquisition unit 307, and the detailed description thereof will be omitted.

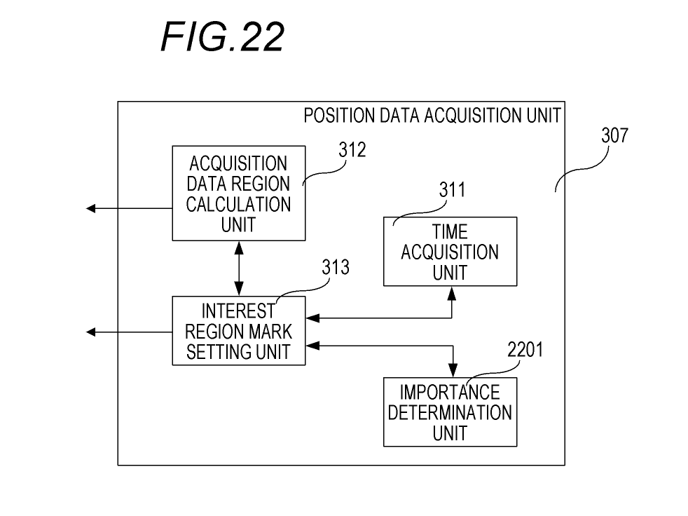

FIG. 22 is a function block diagram of a position data acquisition unit 307 according to the fourth embodiment of the present invention. The position data acquisition unit 307 of FIG. 22 is configured by a similar function block to the position data acquisition device 307 illustrated in FIG. 10, except that an importance determination unit 2201 is added.

The importance determination unit 2201 has a function of reading out an acquisition time listed on a data line newly updated this time and an acquisition time listed on a last data line from a list at the time of designation of the interest region, and determining importances from a difference between both of the acquisition times. Furthermore, the importance determination unit 2201 has a function of sequentially selecting data lines from the list when reproducing and displaying interest region marks and paths, and reading out an acquisition time listed on the selected data line and an acquisition time listed on a last data line, and sequentially determining importances from a difference between both of the acquisition times. Similarly to the second embodiment, the acquisition time used here may be a time from any point of time.

An interest region mark setting unit 313 has a function of determining a method for displaying an interest region mark and a path reflected on a whole image 407 by a display data generation unit 305 in accordance with the importance determined by the importance determination unit 2201, in addition to the function illustrated in FIG. 10.

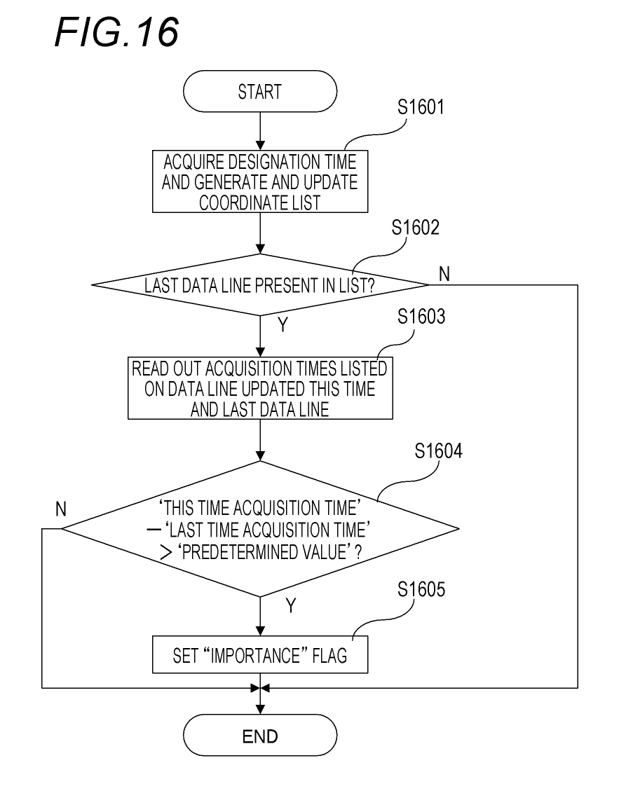

FIG. 16 is a flowchart for illustrating importance determination during screening for explaining the fourth embodiment of the present invention.

Processing shown in FIG. 16 is processing added to the process of Step S507 shown in FIG. 5, for example. Other processing for screening work can be achieved by a process equivalent to that shown in FIG. 5.

In Step S1601, the time acquisition unit 311 acquires a time of designation of an interest region (this time acquisition time) by a user, ant lists the same in the list. Other processing is similar to that of Step S507.

In Step S1602, the importance determination unit 2201 determines whether or not a data line associated with a last item number is present in the list. In a case where the last data line is present, the process advances to Step S1603. In a case where the last data line is not present, the determination of the importance is terminated.

In Step S1603, the importance determination unit 2201 reads out the this time acquisition time listed in Step S1601, and an acquisition time (last time acquisition time) listed on the last data line determined in Step S1602.

In Step S1604, the importance determination unit 2201 deducts the last time acquisition time from the this time acquisition time, and the process advances to Step S1605 in a case where the difference is larger than a predetermined value (threshold), while the determination of the importance is terminated in a case where the difference is the threshold or less.

In Step S1605, the importance determination unit 2201 sets an “importance” flag. This flag is cleared at the time of designation of a next interest region.

Thereafter, in Step S604 shown in FIG. 6, the interest region mark setting unit 313 determines a display method (display form) of data of the interest region mark and the path reflected on the whole image 407 by the display data generation unit 305, in a case where the “importance” flag sets. As long as data with the importance flag and data with no importance flag can be distinguished from each other, any display form may be employed, and for example, shape, line width, size, or color may be changed, or gradation or animation may be added. Furthermore, the importance may be preferably set at a plurality of stages by preparing a plurality of thresholds used in Step S1604. In this case, the display form is preferably changed in accordance with the stages of the importance. Alternatively, an importance reflecting the display of the interest region mark or the path from among importances at the plurality of stages may be selectable.

On the other hand, in a case where the importance is determined and reflects when the interest region mark and the path are reproduced and displayed, Steps S1602 to S1605 should be performed in the process of Step S1306 in FIG. 12. However, “this time acquisition time” is placed with “an acquisition time listed on a data line selected at present”.

A determination condition of the importance used in the present embodiment is not limited to a time interval up to the designation of the next interest region, described above.

For example, the determination condition may be based on an interest region display magnification set at the time of the designation of the interest region. There is a high possibility that when the interest region display magnification is changed to be set to a higher magnification, a portion around the region is a region which should be distinguished from other region.

Alternatively, a UI and a function capable of adding attribution to the interest region at the time of the designation of the interest region may be provided, and the importance may be determined on the basis of the added attribution. Attribution information should be recorded in the list for each interest region. The attribution is information on a property or a state of the interest region, and as long as the information is information useful for detailed observation or diagnosis, any information may be added as the attribution information. For example, the user may select the information among from options such as “normal”, “abnormal”, “pending”, and the like. There is a high possibility that when the attribution is changed, a portion around the region is a region which should be distinguished from other region. Therefore, in a case where attribution added to an interest region on a starting point side of a path is compared with attribution added to an interest region on an ending point side, and there is a difference between them, the “importance” flag should be set on this path. Alternatively, the stage (level) of the importance may be changed depending on a way to change the attribution (for example, the level of the importance is made different in accordance with a case of change from “normal” to “abnormal” and a case of change from “abnormal” to “pending”, etc.).

As the UI for inputting (selecting) the attribution, a configuration, in which an attribution input unit is displayed at the time of the designation of the interest region may be employed, similarly to the interest region display magnification illustrated in FIG. 4. Alternatively, the setting is made by a mouse operation (time of pressing, the number of pressing), in order to distinguish from input of the interest region display magnification.

Moreover, the determination condition of the importance used in the present embodiment may be combination of various conditions, and for example, there is a high possibility that a feature which should be further distinguished exists on a portion around a region where the attribution is changed into “abnormality” after a long period of time. In a case of using various such determination conditions, the information read out from the list by the importance determination unit 2201 should be properly changed in Step S1603.

With the configuration and the behavior according to the fourth embodiment, described above, the user can grasp the feather (importance) of the interest region designated by the screening worker. As a result, a region having a high possibility that the screening worker focuses distinctively from other region can be grasped from the whole image, and work efficiency can be further improved.

### Fifth Embodiment

A fifth embodiment achieving the present invention will be described with reference to the figures.

According to the present embodiment, a function of enabling selection of a path of an interest region designated by a screening worker, and displaying the enlarged image around the selected path is added.

A device configuration can be achieved by a device configuration equivalent to those described in the first to fourth embodiments, and the detailed description thereof will be omitted.

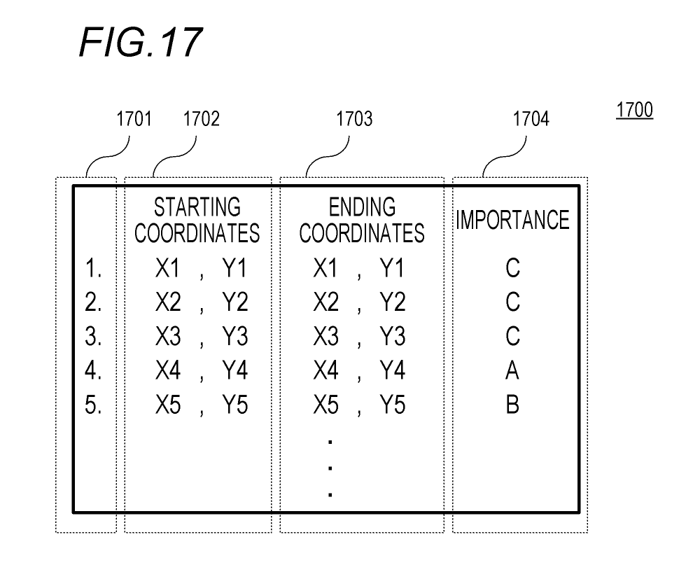

FIG. 17 is an example of a format of a path list for enabling selection of a path according to a fifth embodiment of the present invention.

The path list of FIG. 17 schematically shows an example of a data configuration of path information, and an example of a list image capable of being displayed by an interest region information display unit 405, which is similar to an interest region list shown in FIG. 11. Information, which is not displayed in the list image, may be listed in the path list.

As shown in FIG. 17, a path list 1700 is configured from a path number column 1701, a starting point coordinate column 1702 at a display position of a path in a display device 103, an ending point coordinate column 1703 at the display position of the path, and an importance column 1704, for each item.

Serial numbers are generated and listed in the path number column 1701 in order of display of the paths (order of the designation of second point and subsequent interest regions). In the starting point coordinate column 1702, the starting point coordinates at the display positions of the paths in the display device 103 are associated with path numbers and listed for each line. In the ending point coordinate column 1703, the ending point coordinates at the display positions of the paths in the display device 103 are associated with the path numbers, and listed for each line. In the importance column 1704, the importances of the paths are associated with the path numbers, and listed for each line. Alternatively, feature amounts of the path may be associated with the path numbers and listed in the path list. For example, a distance or a direction of the path is relevant to the feature amount of the path.

This path list 1700 can be generated by listing the display coordinates of the path calculated in Step S603 of FIG. 6, and the importance determined in Step S1615 of FIG. 16 in the flow of screening work, in acquisition order.

Thus, the display information of the path calculated once is recorded in the path list, thereby enabling utilization for determination as to which path is selected, when the path is selected by a mouse pointer, for example. However, when a display magnification or a display region in the display device 103 is changed, the display position coordinates in the list information, or the feature amount needs to be updated.

Determination as to whether or not the path exists at a position of the mouse pointer should be made by using a method of enabling selection of an already drawn figure like a method used in general drawing device and the like.

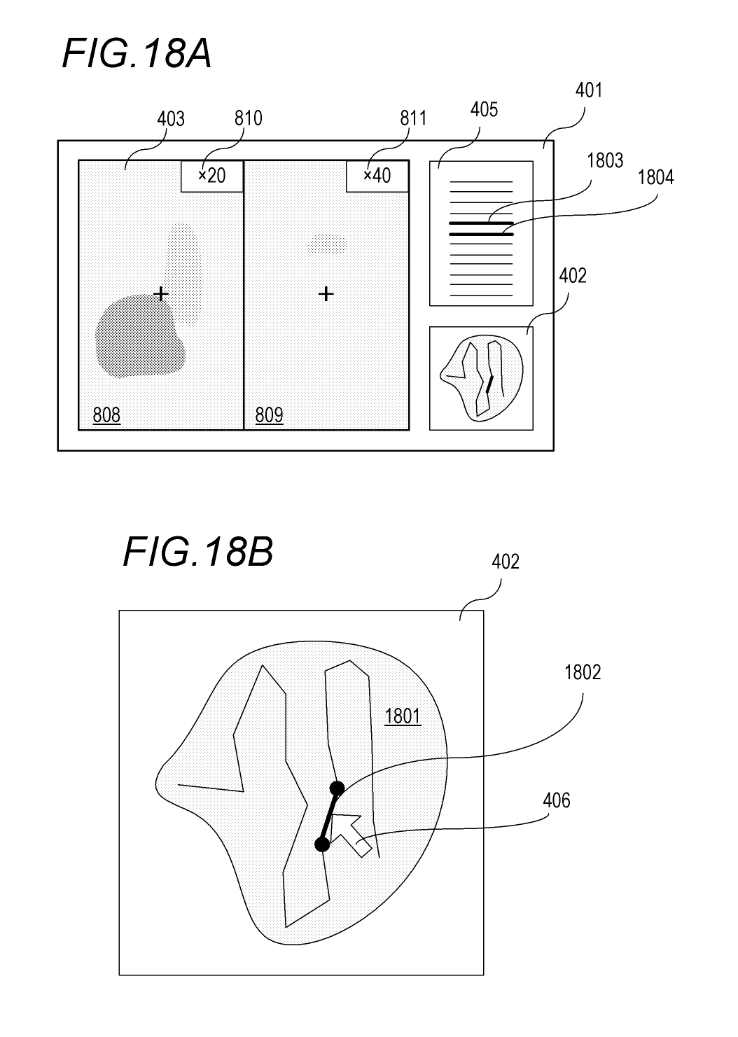

FIG. 18A and FIG. 18B each are an example of a display screen configuration displaying an enlarged image around the path when the path is selected. In this example, an enlarged image around the interest region on a starting point side of the selected path, and an enlarged image of the image around the interest region on an ending point side are displayed.

As shown in FIG. 18A and FIG. 18, a display screen 401 of the display device 103 according to the fifth embodiment is configured, similarly to that of the first embodiment. A whole image display unit 402 displays a whole image 1801 obtained by reducing the size of the whole of captured image data acquired from an imaging apparatus 101. Then, interest region marks and paths created and updated during screening work are displayed on the whole image 1801, and the interest region information display unit 405 displays information of the interest regions generated during screening in a list. The path list shown in FIG. 17 may be displayed.

FIG. 18 shows an example of selecting a path 1802 with a mouse pointer 406 in the display screen 401 configured as described above, and the path 1802 and interest region marks connected thereto on the whole image 1801 are highlighted. Furthermore, items 1803 and 1804 corresponding to the interest region marks are highlighted.

Here, an observation image display unit 403 displays enlarged display images 808 and 809 corresponding to the interest region marks connected to the path 1802 at respective corresponding interest region display magnifications.

With this screen configuration, a user can easily compare detained image of specific continuous interest regions.

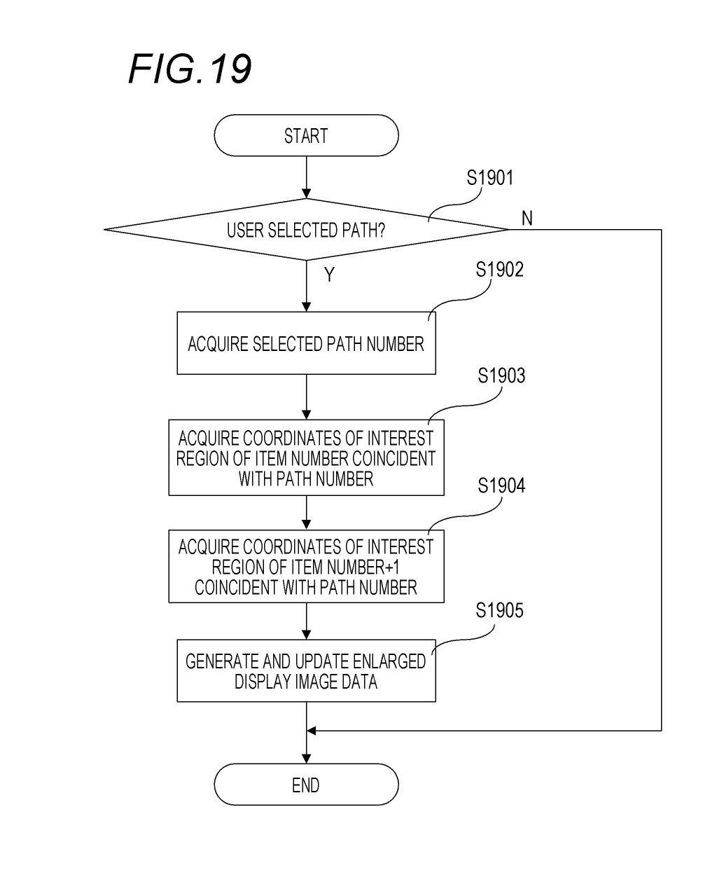

FIG. 19 is a flowchart for illustrating generation of display image data displaying the enlarged image around the selected path.

In Step S1901, a position data acquisition unit 307 determines whether or not the user selects any path from the path list. In a case where the path is selected, the process advances to Step S1902. In a case where the path is not selected, the flow of FIG. 19 is terminated.

In Step S1902, the position data acquisition unit 307 acquires a path number of the path selected from the path list.

In Step S1903, the position data acquisition unit 307 acquires, from the list of the interest regions, position coordinates and an interest region display magnification on a captured image data, corresponding to an interest region listed in an item number coincident with the path number acquired in Step S1902.

In Step S1904, the position data acquisition unit 307 acquires, from the list of the interest regions, position coordinates and an interest region display magnification on captured image data, corresponding to an interest region listed on a next line of the item number coincident with the path number acquired in Step S1902.

Finally, in Step S1905, a display image data acquisition unit 303 reads out image data corresponding to regions of two enlarged display images by an image memory 302 on the basis of the position coordinates and the interest region display magnification acquired by the position data acquisition unit 307. Thereafter, a display data generation unit 305 reflects two enlarged observation image data and updates display data through the display image data acquisition unit 303. A screen of the detailed observation shown in FIG. 18A and FIG. 18B is displayed by using the thus generated display data.

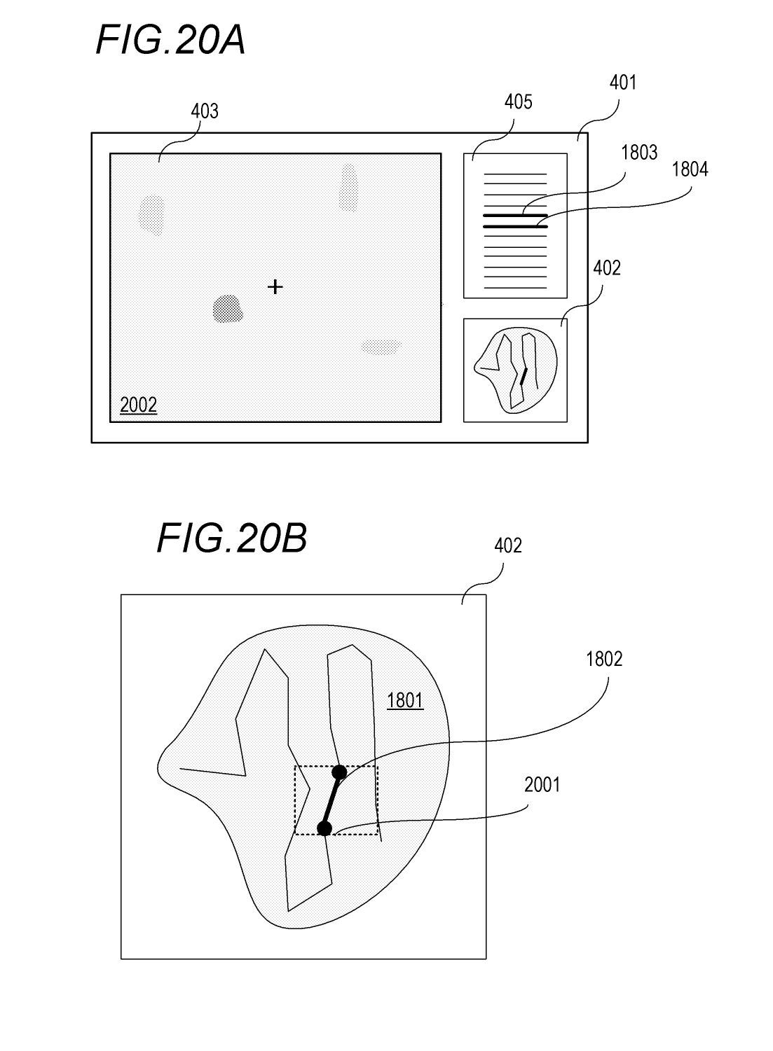

FIG. 20A and FIG. 20B each show another example of a display screen configuration displaying the enlarged image around the path when the path is selected. In this example, the enlarged image including both of an interest region on a starting point side of the selected path, and an interest region on an ending point side of the selected path is displayed.

FIG. 20B shows an example of selecting the path 1802 with the mouse pointer, similarly to an example shown in FIG. 18B, and the path 1802 and the interest region marks connected thereto on the whole image 1801 are highlighted. Furthermore, items 1803 and 1804 corresponding to these interest region marks are highlighted. Here, the observation image display unit 403 displays an enlarged display image 2002 of a region 2001 completely including a region corresponding to the path 1802 at a magnification falling in the observation image display unit 403.

With this screen configuration, the user can easily confirm the detained image of the specific interest regions.

The display image data displaying as in FIG. 20A and FIG. 20B generates as described below, similarly to the flowchart shown in FIG. 19.

That is, in Step S1905, the data acquisition unit 307 determines a display magnification (resolution conversion rate of read out image data) and a region read out from the image memory 302, from position coordinates on the captured image data of the two portions acquired in Steps S1903 and S1904, such that the both fall in the observation image display unit 403. Then, the display image data acquisition unit 303 reads out a target image data on the basis of the region determined by the position data acquisition unit 307 from the image memory 302, and performs resolution conversion. Thereafter, the display data generation unit 305 reflects enlarged observation image data and updates display data through the display image data acquisition unit 303. A screen of the detailed observation shown in FIG. 20A is displayed by using the display data thus generated.

With the configuration and the behavior according to the fifth embodiment, described above, the user can select the specific path from among a sequence of the interest regions designated by the screening worker, and confirm the enlarged images around the path. Thus, the user can select the region, for which detailed observation is performed, on the basis of the feature of the path. As a result, the interest region can be effectively selected, and work efficiency can be further improved.

Furthermore, the aforementioned effect further is improved by combining this embodiment with the fourth embodiment. For example, the user can select the path while grasping the importance, and can easily compare and confirm a detailed image of a region having a high possibility that the screening worker focuses distinctively from other region, or of a portion around the region.

### Sixth Embodiment

A sixth embodiment achieving the present invention will be described with reference to the figures.

According to the present embodiment, a position data acquisition unit 307 records not only position coordinates of an interest region designated by a user but also display track information (display track data) which is a track of movement (scroll) of a display region. Then, a function of providing a display track is provided in addition to the interest region or a path. When the display track is recorded through the whole screening work, data volume becomes enormous, and therefore the display track should be partially recorded. Preferably, determination as to whether the display track needs to be recorded should be made on the basis of information (interest region display magnification, or the like) set to the interest region, the importance of the path described in the fourth embodiment, or the like every time the user designates a new interest region.

For example, in a case where the user sets an interest region display magnification to be higher than other region during screening work, there is a high possibility that screening until a next interest region is designated is performed on a track different from before. According to the present embodiment, an example, in which the display track information is acquired by employing change in setting of the interest region display magnification as a condition, will be described.

A device configuration can be achieved by a device configuration equivalent to those described in the first to fourth embodiments, and the detailed description thereof will be omitted.

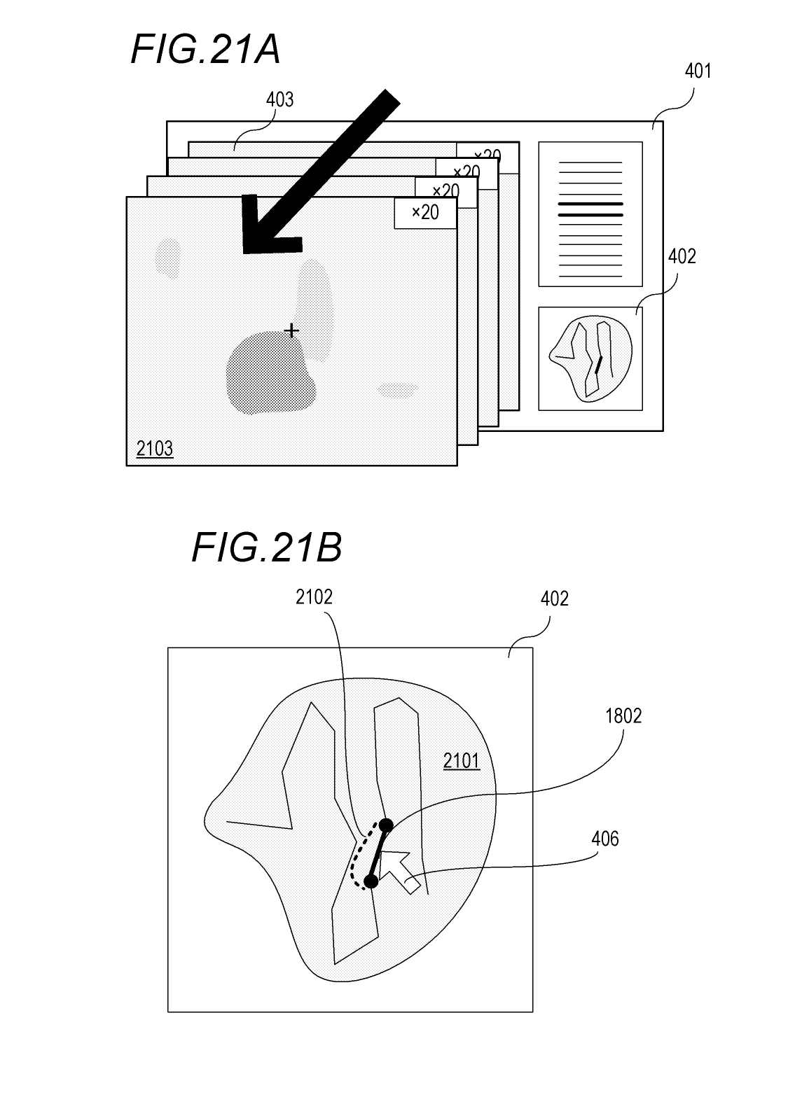

FIG. 21A and FIG. 21B each show an example of a display screen configuration of the display track according to the sixth embodiment of the present invention.

As shown in FIG. 21A, a display screen 401 according to the sixth embodiment is configured similarly to that of the fifth embodiment. As shown in FIG. 21B, a whole image display unit 402 displays a whole image 2101 obtained by reducing the size of the whole of captured image data acquired from an imaging apparatus 101. Then, interest region marks and a path 1802 created and updated during screening work are displayed on the whole image 2101. Moreover, a display track 2102 following regions, which a screening worker has displayed on an observation image display unit 403 during designation of the two interest region forming the path 1802, is displayed. Each element of the display track 2102 is center coordinates of an observation image 409 displayed on the observation image display unit 403 at a certain moment, for example.

Furthermore, FIG. 21B shows an example (described later) of selecting the path 1802 with a mouse pointer 406 on the display screen 401 configured as described above, and the path 1802 and interest region marks connected thereto on the whole image 2101 are highlighted. Moreover, the observation image display unit 403 continuously displays while switching enlarged display images 2103 (reproduction images) at positions equivalent to respective elements of the display track 2102 at predetermined time intervals. Thus, the track, which the user has followed during the screening work (movement state of the display region), is reproduced like an animation. A display magnification of the enlarged display image 2103 or the switching time interval can be arbitrarily set.

Here, the acquisition of the display track information during the screening according to the sixth embodiment of the present invention can be achieved as described below.

That is, the flow of the acquisition of the interest region illustrated in FIG. 5 is repeated by employing the change of the interest region display magnification as a trigger. At this time, the position data acquisition unit 307 acquires the center coordinates of the observation image 409 (see FIG. 4A) displayed by the observation image display unit 403 at that time. The acquisition of the center coordinates is repeated at predetermined time interval (for example, several milliseconds to several seconds). Then, the position data acquisition unit 307 records a track of the acquired center coordinates on a track list (display track data) different from the list of the interest region. Ina case where a next interest region is designated, the record of the track of the center coordinates is terminated. The track list is associated with the interest region and stored. A condition for starting acquiring display track information used in the present embodiment is not limited to the change of the interest region display magnification, which is described above. For example, the display track may be recorded by employing the change of the importance (growing of the importance) of the path of the interest regions shown in the fourth embodiment as a trigger. Furthermore, change of the display magnification (see 404 of FIG. 4A) of the observation image 409 may be employed as a trigger. As long as a processing load or storage capacity does not become a problem, all display tracks during screening work may be recorded.

Furthermore, the display of the display track can be achieved as follows.

That is, the additional flow of the interest region mark described in Steps S1401 to S1403 of FIG. 14 is repeated by employing the termination of the creation of the track list as a trigger. At this time, the track list is used in place of the list of the interest region.

On the other hand, in a case of reflecting the display track when reproducing and displaying the interest region mark and the path, the aforementioned track display flow (corresponding to Steps S1401 to S1403 of FIG. 14) may be performed in the process of Step S1306 in FIG. 12. Which track list should be used can be followed from the interest region listed on the data line selected in Step S1306.

With the configuration and the behavior according to the sixth embodiment, described above, as to a region having a high possibility that the screening worker focuses distinctively from other region, the relation between the track following for screening and the path can be grasped. As a result, the interest region can be efficiently selected, and work efficiency can be further improved.

Furthermore, the relation between a portion determined as an interest region by the screening worker, and a portion not determined as the interest region can be grasped, thereby enabling more adequate application for pathology education.

Moreover, the aforementioned effect is further improved by combining this embodiment with the fourth embodiment and the fifth embodiment. For example, as shown in FIG. 21, the user can select the path while grasping the importance or the display track, and can easily compare and confirm a detailed image (enlarged display image 2103) around a region having a high possibility that the screening worker focuses distinctively from other region.

The display of the enlarged display image 2103 of the display track can be achieved as described below.

That is, processing similar to the generation and display flow of the display data during detailed observation illustrated in FIG. 8 is repeated by employing the selection of the path as a trigger. At this time, instead of generating and displaying the display data every time the user selects the interest region from the list, coordinates are sequentially selected from the track list at anytime interval, and the display data of the enlarged display image 2103 is generated and displayed at any display magnification.

### Seven Embodiment

The present invention provides a system or a device with a recording medium (or a storage medium) recording a program cord of a software achieving all or a part of the functions according to the aforementioned embodiments. Then, a computer (or CPU or MPU) of the system or the device reads out and executes the program cord stored in the recording medium, thereby enabling the functions. In this case, the program cord itself, which is read out from the recording medium, achieves the functions of the aforementioned embodiments, the recording medium recording the program cord configures the present invention. Furthermore, the computer executes the read-out program cord, an operating system (OS) running on the computer and the like performs a part of or all of actual processing. A case where the aforementioned functions are achieved by the processing is also included in the present invention. Moreover, the program cord read out from the recording medium is written in a memory provided on a function expansion card inserted into the computer or a function expansion unit connected to the computer. Thereafter, a case where a CPU provided on the function expansion card or the function expansion unit, or the like performs a part of or all of the actual processing on the basis of the instruction of the program cord, and the functions according to the aforementioned embodiments are achieved by the processing are also included in the present invention. In a case where the present invention is applied to the aforementioned recording medium, the recording medium stores a program cord corresponding to the flowchart previously described.

### Other Embodiment

The configurations described in the first to seventh embodiments can be used by combining the embodiments with each other.

Accordingly, a person skilled in the art will easily conceive of appropriately combining various techniques in the aforementioned respective embodiments to configure a new system, and a system obtained by such various combination also belongs to the category of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-013323, filed on Jan. 25, 2012 and Japanese Patent Application No. 2012-251760, filed on Nov. 16, 2012, which are hereby incorporated by reference herein in their entirety.

What is claimed is:

1. An image data generation apparatus generating data for displaying information of an interest region designated by a user along with an image on a display device, the image data generation apparatus comprising:
a display data generation unit that generates, from data of an original image, data of a display image corresponding to all or a part of a region of the original image, and generates data of a display screen including the display image; and
a position data acquisition unit that, when a user designates an interest region with respect to the display image displayed on the display device on the basis of the data of the display screen, acquires data of a position designated as the interest region, wherein
in a case where a plurality of interest regions are designated with respect to the original image, the position data acquisition unit creates list information, in which data of respective positions of the plurality of interest regions is associated with designation order, and
in a case where data of a position of a newly designated interest region is acquired by the position data acquisition unit, the display data generation unit generates data for superimposing and displaying, on the display image, a mark indicating the position of the newly designated interest region, and in a case where data of a position of an interest region designated last time exists in the list information, the display data generation unit generates data for superimposing and displaying, on the display image, also a path connecting the position of the interest region designated last time and the position of the newly designated interest region.

2. The image data generation apparatus according to claim 1, wherein
the display data generation unit also generates data for superimposing and displaying, on the display image, marks indicating the respective positions of the plurality of interest regions, and paths sequentially connecting the positions of the plurality of interest regions, on the basis of data of the positions of the plurality of interest regions and designation order included in the list information.

3. The image data generation apparatus according to claim 1, wherein
the interest region is designated by the user while a display region that is a region displayed as the display image is moved, and
the position data acquisition unit generates display track information recording a track of movement of the display region.

4. The image data generation apparatus according to claim 3, wherein
the position data acquisition unit determines whether or not a display track needs to be recorded every time an interest region is designated, and records the display track until a next interest region is designated, only in a case of determining that the display track needs to be recorded.

5. The image data generation apparatus according to claim 1, wherein
the display data generation unit generates data for superimposing and displaying, on the display image, marks indicating the respective positions of the plurality of interest regions included in the list information, and paths sequentially connecting the positions of the plurality of interest regions, such that the marks and the paths are sequentially displayed in accordance with designation order of the respective interest regions.

6. The image data generation apparatus according to claim 5, wherein
information on time when the interest regions are designated is further associated with data of the positions of the interest regions in the list information, and
the display data generation unit generates data for superimposing and displaying, on the display image, the marks indicating the respective positions of the plurality of interest regions, and the paths sequentially connecting the positions of the plurality of interest regions, such that the marks and the paths are sequentially displayed in accordance with designation order of the respective interest regions at time intervals corresponding to time intervals at which the respective regions are designated.

7. The image data generation apparatus according to claim 1, further comprising:
an importance determination unit that determines an importance of each of the paths, wherein
the display data generation unit generates data in which a display form at a time of superimposing and displaying the path on the display image is changed in accordance with the importance of the path.

8. The image data generation apparatus according to claim 7, wherein
information on time when the interest regions are designated is further associated with data of the positions of the interest regions in the list information, and
the importance determination unit determines the importance of each of the paths on the basis of a difference between a time when an interest region on a starting point side of the path is designated and a time when an interest region on an ending point side of the path is designated.

9. The image data generation apparatus according to claim 7, wherein
attribution information added by the user is further associated with data of the positions of the interest regions in the list information, and
the importance determination unit determines the importance of each of the paths on the basis of a difference between attribution added to an interest region on a starting point side of the path and attribution added to an interest region on an ending point side of the path.

10. The image data generation apparatus according to claim 1, wherein
in a case where the interest region is designated by the user while a display region that is a region displayed as the display image is moved, a track of movement of the display region is recorded as display track information and
the display data generation unit also generates data for superimposing and displaying, on the display image, a display track indicating a track of movement of the display region from designation of a certain interest region up to designation of a next interest region on the basis of the display track information.

11. The image data generation apparatus according to claim 10, wherein
the display data generation unit generates data of a plurality of reproduction images for reproducing the movement of the display region from the designation of the certain interest region up to the designation of the next interest region on the basis of the display track information, and generates data for displaying the plurality of reproduction images on the display screen.

12. The image data generation apparatus according to claim 1, wherein
in a case where the user selects any path among a plurality of the paths superimposed and displayed on the display image, the display data generation unit generates data of two images composed of an image of a region including an interest region on a starting point side of the selected path and an image of a region including an interest region on an ending point side of the selected path, and generates data for displaying the two generated images on the display screen.

13. The image data generation apparatus according to claim 1, wherein
in a case where the user selects any path among a plurality of the paths superimposed and displayed on the display image, the display data generation unit generates data of an image of a region including both of interest regions on a starting point side and an ending point side of the selected path, and generates data for displaying the generated images on the display screen.

14. The image data generation apparatus according to claim 1, wherein
in a case where the user selects any path among a plurality of the paths superimposed and displayed on the display image, the display data generation unit generates data for highlighting the selected path.

15. The image data generation apparatus according to claim 1, wherein
the display data generation unit generates data of an list image for displaying information of each of the plurality of interest regions in a list on the basis of the list information, and generates data for displaying the list image on the display screen.

16. The image data generation apparatus according to claim 15, wherein
in a case where the user selects an interest region from the list image, the display data generation unit generates, from the data of the original image, data of an image of a region including the selected interest region, and generates data for displaying the generated image on the display screen.

17. The image data generation apparatus according to claim 15, wherein
in a case where the user selects a plurality of interest regions from the list image, the display data generation unit generates data of a plurality of images of regions including the selected plurality of interest regions respectively, and generates data for displaying the generated plurality of images side by side on the display screen.

18. The image data generation apparatus according to claim 1, wherein
the display data generation unit generates data for displaying the path in such a display form as to be capable of visually distinguishing a starting point side and an ending point side of the path.

19. An image processing system comprising:
an imaging apparatus or an image storage device;
a display device; and
an image data generation apparatus generating data for performing display on the display device by using data of an image acquired from the imaging apparatus or the image storage device, wherein
the image data generation apparatus is the image data generation apparatus according to claim 1.

20. An image data generation apparatus generating data for displaying information of an interest region designated by a user along with an image on a display device, the image data generation apparatus comprising:
a display data generation unit that generates, from data of an original image, data of a display image corresponding to all or a part of a region of the original image, and generates data of a display screen including the display image; and
a position data acquisition unit that acquires list information in which designation order and data of respective positions of a plurality of interest regions designated by a user with respect to the original image are associated with each other and listed, wherein
the position data acquisition unit acquires, from the list information, the data of the respective positions of the plurality of interest regions and the designation order, and
the display data generation unit generates data for superimposing and displaying, on the display image, marks indicating the respective positions of the plurality of interest regions, on the basis of the data of the respective positions of the plurality of interest regions and the designation order acquired from the list information.

21. The image data generation apparatus according to claim 20, wherein
the display data generation unit generates data for superimposing and displaying, on the display image, marks indicating the respective positions of the plurality of interest regions, and paths sequentially connecting the positions of the plurality of interest regions, on the basis of the data of the respective positions of the plurality of interest regions and the designation order acquired from the list information.

22. The image data generation apparatus according to claim 21, wherein
the display data generation unit generates data for superimposing and displaying, on the display image, marks indicating the respective positions of the plurality of interest regions included in the list information, and paths sequentially connecting the positions of the plurality of interest regions, such that the marks and the paths are sequentially displayed in accordance with designation order of the respective interest regions.

23. The image data generation apparatus according to claim 22, wherein
information on time when the interest regions are designated is further associated with data of the positions of the interest regions in the list information, and
the display data generation unit generates data for superimposing and displaying, on the display image, the marks indicating the respective positions of the plurality of interest regions, and the paths sequentially connecting the positions of the plurality of interest regions, such that the marks and the paths are sequentially displayed in accordance with designation order of the respective interest regions at time intervals corresponding to time intervals at which the respective regions are designated.

24. The image data generation apparatus according to claim 21, further comprising:
an importance determination unit that determines an importance of each of the paths, wherein
the display data generation unit generates data in which a display form at a time of superimposing and displaying the path on the display image is changed in accordance with the importance of the path.

25. The image data generation apparatus according to claim 24, wherein
information on time when the interest regions are designated is further associated with data of the positions of the interest regions in the list information, and
the importance determination unit determines the importance of each of the paths on the basis of a difference between a time when an interest region on a starting point side of the path is designated and a time when an interest region on an ending point side of the path is designated.

26. The image data generation apparatus according to claim 24, wherein
attribution information added by the user is further associated with data of the positions of the interest regions in the list information, and
the importance determination unit determines the importance of each of the paths on the basis of a difference between attribution added to an interest region on a starting point side of the path and attribution added to an interest region on an ending point side of the path.

27. The image data generation apparatus according to claim 21, wherein
in a case where the interest region is designated by the user while a display region that is a region displayed as the display image is moved, a track of movement of the display region is recorded as display track information and
the display data generation unit also generates data for superimposing and displaying, on the display image, a display track indicating a track of movement of the display region from designation of a certain interest region up to designation of a next interest region on the basis of the display track information.

28. The image data generation apparatus according to claim 27, wherein
the display data generation unit generates data of a plurality of reproduction images for reproducing the movement of the display region from the designation of the certain interest region up to the designation of the next interest region on the basis of the display track information, and generates data for displaying the plurality of reproduction images on the display screen.

29. The image data generation apparatus according to claim 21, wherein
in a case where the user selects any path among a plurality of the paths superimposed and displayed on the display image, the display data generation unit generates data of two images composed of an image of a region including an interest region on a starting point side of the selected path and an image of a region including an interest region on an ending point side of the selected path, and generates data for displaying the two generated images on the display screen.

30. The image data generation apparatus according to claim 21, wherein
in a case where the user selects any path among a plurality of the paths superimposed and displayed on the display image, the display data generation unit generates data of an image of a region including both of interest regions on a starting point side and an ending point side of the selected path, and generates data for displaying the generated images on the display screen.

31. The image data generation apparatus according to claim 21, wherein
in a case where the user selects any path among a plurality of the paths superimposed and displayed on the display image, the display data generation unit generates data for highlighting the selected path.

32. The image data generation apparatus according to claim 21, wherein
the display data generation unit generates data of an list image for displaying information of each of the plurality of interest regions in a list on the basis of the list information, and generates data for displaying the list image on the display screen.

33. The image data generation apparatus according to claim 32, wherein
in a case where the user selects an interest region from the list image, the display data generation unit generates, from the data of the original image, data of an image of a region including the selected interest region, and generates data for displaying the generated image on the display screen.

34. The image data generation apparatus according to claim 32, wherein
in a case where the user selects a plurality of interest regions from the list image, the display data generation unit generates data of a plurality of images of regions including the selected plurality of interest regions respectively, and generates data for displaying the generated plurality of images side by side on the display screen.

35. The image data generation apparatus according to claim 21, wherein
the display data generation unit generates data for displaying the path in such a display form as to be capable of visually distinguishing a starting point side and an ending point side of the path.

36. An image processing system comprising:
an imaging apparatus or an image storage device;
a display device; and
an image data generation apparatus generating data for performing display on the display device by using data of an image acquired from the imaging apparatus or the image storage device, wherein
the image data generation apparatus is the image data generation apparatus according to claim 20.

37. An image data generation method of generating data for displaying information of an interest region designated by a user along with an image on a display device, the image data generation method comprising:
a display data generation step in which a computer generates, from data of an original image, data of a display image corresponding to all or a part of a region of the original image, and generates data of a display screen including the display image; and
a position data acquisition step in which, when a user designates an interest region with respect to the display image displayed on the display device on the basis of the data of the display screen, the computer acquires data of a position designated as the interest region, wherein
in the position data acquisition step, in a case where a plurality of interest regions are designated with respect to the original image, list information is created in which data of respective positions of the plurality of interest regions is associated with designation order, and
in the display data generation step, in a case where data of a position of a newly designated interest region is acquired in the position data acquisition step, data for superimposing and displaying, on the display image, a mark indicating the position of the newly designated interest region is generated, and in a case where data of a position of an interest region designated last time exists in the list information, data for superimposing and displaying, on the display image, also a path connecting the position of the interest region designated last time and the position of the newly designated interest region is generated.

38. An image data generation method of generating data for displaying information of an interest region designated by a user along with an image on a display device, the image data generation method comprising:
a display data generation step in which a computer generates, from data of an original image, data of a display image corresponding to all or a part of a region of the original image, and generates data of a display screen including the display image; and
a position data acquisition step in which the computer acquires list information in which designation order and data of respective positions of a plurality of interest regions designated by a user with respect to the original image are associated with each other and listed, wherein
in the position data acquisition step, the data of the respective positions of the plurality of interest regions and the designation order are acquired from the list information, and
in the display data generation step, data for superimposing and displaying, on the display image, marks indicating the respective positions of the plurality of interest regions is generated on the basis of the data of the respective positions of the plurality of interest regions and the designation order acquired from the list information.

39. The image data generation method according to claim 38, wherein
in the display data generation step, data for superimposing and displaying, on the display image, marks indicating the respective positions of the plurality of interest regions, and paths sequentially connecting the positions of the plurality of interest regions is generated on the basis of the data of the respective positions of the plurality of interest regions and the designation order acquired from the list information.

40. A non-transitory recording medium recording a program for causing a computer to execute the respective steps of the image data generation method according to claim 37.

41. A non-transitory recording medium recording a program for causing a computer to execute the respective steps of the image data generation method according to claim 38.
